(19) United States
(12) Patent Application Publication
(10) Pub. No.: US 2020/0134551 A1
(43) Pub. Date: Apr. 30, 2020

(54) SYSTEM FOR FACILITATING INTERNATIONAL TRADE AND METHOD

(71) Applicant: Simranjit Singh, Milton (CA)

(72) Inventor: Simranjit Singh, Milton (CA)

(21) Appl. No.: 16/184,905

(22) Filed: Nov. 8, 2018

(30) Foreign Application Priority Data
Oct. 29, 2018 (CA) 3022440

(51) Int. Cl. G06Q 10/08; G06Q 20/10

(52) U.S. Cl. CPC G06Q 10/0831; G06Q 10/0838; G06Q 20/10

(57) ABSTRACT

A system for facilitating international trade including a web-based, internet application, programmed to connect businesses and licensed customs brokers to businesses anywhere in the world. This application acts as a third-party gateway, providing a system and method of facilitating international trade between businesses and governments and avoiding unnecessary errors and delays in the traditional customs brokerage process.

### BACKGROUND OF THE INVENTION

This application claims benefit to Canada National Application Serial No. 3,022,440 filed Oct. 29, 2018 the disclosure of which is incorporated herein by reference in its entirety. The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of web-based applications of existing art and more specifically relates to a web-based application for business trading.

### RELATED ART

In this paradigm of capitalism, modern manufacturing activity involves sourcing goods from multiple countries to create a finished product, and therefore its normal for a finished product to have subcomponents made in different countries. Manufacturers have global supply chains to obtain products from suppliers from other countries, to create an end-product which contains multiple products made in different countries. Categorizing end-products according to this is critical to the modern manufacturing processes, and providing an efficient global customs solution is essential for this age of the industrial revolution. When an end-product contains multiple inputs made in different countries, the dilemma that manufacturers face is classification of their product such as assigning a harmonization number, a tariff treatment, and classifying the origination of their product, without speculation. A suitable solution is desired.

U.S. Pub. No. 2010/0023422 to Cliff Thompson relates to a system and method for processing import/export transactions. The described system and method for processing import/export transactions includes import/export transactions whereby an item is to be transported from one country to another are automated. An invoice containing a list of one or more part numbers is entered in at a web site and loaded to a server containing a database. A database is of part numbers and their corresponding tariff classification numbers. The uploaded invoice will be compared to the database to output a data record whereby the one or more part numbers uploaded in the invoice now have tariff classification numbers and daily calculation associated therewith This data record can then be accessed over the Internet at another web site by a customs broker for use in transmitting a report to a customs entity.

### SUMMARY OF THE INVENTION

In view of the foregoing disadvantages inherent in the known web-based application art, the present disclosure provides a novel system for facilitating international trade. The general purpose of the present disclosure, which will be described subsequently in greater detail, is to provide a web-based, internet application, programmed to connect businesses (i.e. importers and exporters) and licensed customs brokers to businesses anywhere in the world.

A system for facilitating international trade is disclosed herein. The system for facilitating international trade comprising a server including a processor and a memory in communication with the processor. The memory includes a database comprising at least four tables. The at least four tables include a first-table including at least one customs-broker profile, a second-table including at least one trade-company profile, a third-table including at least one customs-stage file, and a fourth-table including at least one administrative-file. The system further comprises a device including a user-interface configured to enable communication with the server. This system acts as a third-party gateway, providing a system and method of facilitating international trade between businesses and governments and avoiding unnecessary errors and delays in the traditional customs brokerage process.

The web application inputs the contents of an import by using an online import declaration form, attaching shipping documents (i.e. customs clearance documents), to declare the arrival information for the subject import. The system transfers the declaration to a licensed customs broker, in a country, where the customs clearance entry is requested, the licensed customs broker. The application provides an interface of how audit-proof customs brokerage services are designed to protect international businesses from foreign government audits.

Further, the application provides trade advisory services, in which businesses can review import and export rules and regulations for goods and contact trade advisors for assistance globally. The application provides customs compliance services, in which businesses can receive post-audit reports for their imports and exports globally.

A method for facilitating international trade is also disclosed herein. The method for facilitating international trade includes the steps of providing a system for facilitating the international trade; receiving at the server a request for retrieval of the at least one administrative-file via a trade-company profile; receiving at the server at least one shipping-information file; storing the at least one shipping-information file on the database; identifying an appropriate customs-broker from the at least one customs-broker profile; sending the shipping-information file to the appropriate customs-broker; identifying an appropriate customs-agency from at least one customs-agency profile; sending the at least one shipping-information file to the appropriate customs-agency; receiving at the server an agency-decision; generating an agency-decision file; and sending the agency-decision file to the appropriate customs-broker.

The method may further include the steps of: receiving at the server an agency-approval; generating an agency-approval file; sending the agency-approval file to the appropriate customs-broker; receiving at the sever a release-request; generating a release-request file; storing the release-request file on the database; and sending the release-request file to the trade-company profile. Additional steps may include: receiving a customs-update from the appropriate customs-agency; generating a customs-update file; saving the customs-update file on the database; and sending the customs-update file to the trade-company profile.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a system for facilitating international trade, constructed and operative according to the teachings of the present disclosure.

FIG. 1 is a diagram illustrating the system facilitating international trade, according to an embodiment of the present disclosure.

FIG. 2 is a diagram illustrating the system facilitating international trade, according to an embodiment of the present disclosure.

FIG. 3A is a diagram illustrating the system facilitating international trade, according to an embodiment of the present disclosure.

FIG. 3B is a diagram illustrating the system facilitating international trade, according to an embodiment of the present disclosure.

FIG. 4 is a diagram illustrating the system facilitating international trade, according to an embodiment of the present disclosure.

FIG. 5 is a diagram illustrating the system facilitating international trade, according to an embodiment of the present disclosure.

FIG. 6 is a diagram illustrating the system facilitating international trade, according to an embodiment of the present disclosure.

FIG. 7 is a diagram illustrating a method of use for facilitating international trade, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a web-based application and more particularly to system which is designed to connect importers and exporters whose product(s) are approved to enter and legally be traded in the marketplace of member-nations, and therefore, the respective importers and exporters must obtain licenses, special permits and authorization for the particular exchange of good(s) that the importer or exporter desires to facilitate.

Generally, the system for facilitating international trade or world customs brokerage service is a web-based, internet application, programmed to connect businesses (i.e. importers and exporters) and licensed customs brokers to businesses anywhere in the world. This application acts as a third-party gateway, providing systems and methods of facilitating international trade between businesses and governments and avoiding unnecessary errors and delays in the traditional customs brokerage process.

The application is a third-party server connecting businesses and trade professionals together. The invention seeks to redefine the conventional idea of what world customs is by networking with licensed customs brokers who facilitate trade in their country by helping businesses enter new markets and eliminating trade barriers in their country. The application is a global customs brokerage interface providing businesses estimations of duty and taxes, processing customs clearances, and monitoring customs compliance services through an internet-based platform worldwide. The application hosts a network of accredited trade advisors, licensed customs brokers and other shipping intermediaries on one interface to streamline the supply chain of businesses around the world.

The system is designed to provide customs brokerage services through an interface that is designed to protect businesses from contingency audits by customs agency. The application is designed for interconnectedness, where international businesses can use one platform for release, accounting and compliance of their good(s) through a single platform. Therefore, it increases the transparency and visibility in international trade by allowing businesses to connect licensed customs brokers in any country apart of the World Trade Organization. The system contains a database of customs tariff, harmonization codes, customs rules and regulations for goods of every country where a service is provided.

The web application is divided into a number of phases for development, for this summary describes how an import release request is processed: 1. A user connects to the web application inputs the contents of an import by using an online import declaration form, attaching shipping documents (i.e. customs clearance documents), to declare the arrival information for the subject import. Importers may submit a declaration enclosing the shipment details for a customs broker to identify the shipment when it arrives at the border, the customs agency uses the import declaration to clear the cargo upon entry into the destination country; 2. Then, the system transfers the declaration to a licensed customs broker, in the country, where the customs clearance entry is requested, the licensed customs broker confirms the legal requisites by auditing the shipping information, and upon approval, using an authorized server connecting to the respective customs agency, submits the shipping information to the customs agency for an arrival notification and clearance request. The server conducts a risk assessment of the information and initiates an inspection report to verify the declaration, estimates the payment of duty and taxes; 3. If the declaration is approved by the customs agency, the approval is sent to the customs broker, and the customs broker, processes the release request on the web-application, as a notification of release with an entry number to the importer of record. The server provides a global web-based interface for tracking, and continuously monitoring the customs clearance process, recognizing any possible delays and alterations in the shipping process. 4. Upon release notification, the importer is charged a service fee for processing the release, which will be due by credit card or electronic payment.

The interface will be made of the pre-release, release and post-release, customs service: 1. In the pre-release stage, an importer's customs documentations will be either (organically made) or (validated). If they require this service, hence they are the customer, wherefore they choose to enlist into the product of their choice. In this stage, freelancers or contractors can be accessed, where trade professionals can exercise their skills by providing service outside of their regular working hours; 2. In the release stage, an importer will make a simple declaration of the product/good they are importing, and a release agent will process the request. In this stage, release agents in respective countries can be used, i.e. sub-agency agreements can be generated via the network of customs brokers, or shipping intermediaries as well as trade advisors apart of the global network; 3. In a post-release stage, a compliance specialist will analyze the release, and the documentations provided, along with the record(s) in the existing system to study the compliance of the product/good(s) if there are any noticeable errors the importer will be informed, and advised of for corrections, which can be compensated for, periodically.

The system processes external procurement, also known as outsourcing logistics, in which a service provider sources the fulfillment of some logistical services, such as freight forwarding, customs brokerage services, warehousing and distribution and general freight carriage to a third-party logistics provider.

The system uses logistics service providers using a supply chain network sourcing capital, resources, and labor, which is scarce for users since, the knowledge of implementing the complete logistical process requires knowledge and support system is absent in enterprise business models.

Cost(s) of fulfillment are calculated by an integrated process of mapping all the services required by a user, and the methods and systems revealed in the logistics service provider's system. The system provider has a major impact of analysing the structure of cost(s) in the outsourcing enterprise through its allocation process of enrolling logistic service providers, in the global marketplace.

The logistics service constructs a fulfillment plan with the highest possible supply chain solution at its core an integrated operational logistics plan is automated for select users on a needs-basis designed specifically for their logistical support challenges. Operational collaboration is only possible if the logistics service providers operate completely in the fulfillment of their daily tasks, and therefore, coexistence and cooperation are of crucial importance in the success of this system.

The allocation process depends on the logistical service providers is to happen using the service provider's own resources, such that, each article or each service must be assigned for execution either to the own deployment or to an outside supplier, in order to calculate the fulfillment costs for a single item, a mapping of all other items has to be provided.

In addition, external procurement fulfills raw materials, vendor parts or services, by connecting buyers and sellers on a logistics service platform, where, buyers and sellers are approved to buy or sell their goods in a particular nation, pertaining to a nation's trade laws.

The central focus of this system consists in the inclusion of new highlights of practical relevance, for possibilities of sub-contraction and cooperative planning approaches to the operational logistical planning in the commercial international shipping market.

This system reveals the concepts, models and algorithms for increasing efficiency in the operational transportation planning on a global, domestic and local level that include the sub-contraction and collaborative planning concepts developed beyond the current environment of trade. The system and methods of these concepts results in the extension of the investigated problems of a lack of interconnectedness within the global logistics environment between shipping intermediaries (i.e. freight brokers and, freight forwarders) cargo carriers (i.e. air, ocean, rail and ground carriers), national governments and their bodies of organizations (i.e. foreign customs agencies, other government departments), trade advisors (i.e. customs brokers and trade advisors) in the international community signors of the World Trade Organization (WTO) and signors of the GATT.

This system reveals an internet-based logistics platform that integrate logistics by facilitating international trade between importers (buyers) and exporters (sellers), on a platform that that handles international supply chain management, through its logistics integration approach (step-by-step) supporting supply chains from sourcing raw materials to the delivering goods to the final consumers around the world. This system is designed to support operational planning with global logistics providers who will be sub-contracted in a collaborative trade gateway facilitating trade on an international level. It may also be possible for the system to govern the trade network directly, reducing or eliminating the need for local agents and representatives. Consequently, it may be possibly for entities to reduce overhead through allowing the system to govern and control the trade network, while also potentially facilitating modification and expansion of operations accordingly.

The system facilitates, a network of global logistics providers from cargo carriers, freight forwarders, customs brokers, trade advisors, warehousing and distribution fulfillment centres.

The system integrates logistics services provider onto the system, through its safety and security initiatives that are up-to WTO standards, and backed by the rules and regulations of the US-CBP and CBSA. While those entities (and related entities) are referred to in the embodiments herein, it is understood that the system may be used and applied with any customs and/or border control entity as required, either as host or as a party to a transaction.

Logistics optimization approaches for the future automatization of processes, by increasing the logistics planning quality while supporting (or even replacing) human decision makers, from a control panel of a central higher hierarchy level from the system.

The system maintains its own logistics service resources, and it is adjusted more accurately, efficiently improving the possibilities of an interconnected logistics service environment on the global, domestic and local stage.

The system processes logistics solutions through the structure of costs, provided to users, through its supply chain network. The outsourcing structure generates a comparative field of specialized logistics service providers whom are highly skilled in niche-market(s).

This system bundles and schedules transportation requests received from users in a unique way for fulfillment. In order to maximize profit, the system fulfills these requests by outsourcing logistics providers, selecting shipping intermediaries according to their niche-market for businesses, sourcing them by entrusting further independent service providers (i.e. contractors) for the execution of the logistics service requests.

The system does not filter the service request randomly, but, during the initial on-boarding stage, the logistics service providers specify their operations, which are converted into an algorithm, and pattern-code and, specific requests will be sent/received by these logistics providers, in accordance to the user(s) requesting quotations. This feature eliminates the unnecessary requests for quotations sent to logistics service providers, which may result in inefficiency and long-term service outages.

Logistics integration involves (multi-stage planning), the request portfolio is split into subsets that are assigned to the clusters by applying a rules in the system, which takes into account the subsequent optimization requests and features. The main idea of logistics integration model is to assign as many requests as possible logistics provider according to their specific areas of service, and on the basis of a costs assessment between logistics providers, the user's supply chain is optimized. This procedure can be repeated in several iterations, thus, analyzing several simulations of logistics processes, described later. Time consumption is reduced through this procedure by preforming computed sets of scenarios for logistical services, and therefore, only the logistics service providers with the best assessments are chosen for the next possible division.

If the total demand is higher than the capacity of the logistics provider, the algorithm selects a number of logistics providers to service the user. The task of the integrated operational logistics planning consists in establishing a feasible fulfillment plan with minimal execution costs.

This system offers willingness to collaborate with logistics providers, allowing shipping intermediaries to earn additional profits. The platform allows for sharing the request for quotation and coordinates the deployment process across the service providers available, bringing together a collaboration of economies of scale for users on the system.

Operational synergy: increased optimization to better utilize the existing resources, e.g. logistics service providers are given requests according to their expertise, order-sharing principles are valued between various logistics providers;

Coordination synergy: cooperation of between the logistics providers, while keeping the existing network structure enclosed, e.g., the system provides a centralized planning system

Network synergy: long-term cooperation between logistics providers and the system, creating a joint-network structure and joint-investments, e.g., interconnectivity is increased between logistics service providers

The main purpose of this system's cooperative structure is to find an equilibrium between the demanded and the available logistics resources by interconnecting a user's request. This interconnected network of logistics providers exchange information about requests and manage capacity balancing by using the collaborative space among logistics service providers on a collective interface. Within the interchange, the requests are assigned to applicable logistics providers, categorized according to the type of service requested, which is then bundled together with several logistics providers to execute a user's request.

This collaboration type is a powerful measure to improve the integrated operational logistics planning of international trade. The cluster of logistics providers, the extended portfolio of requests causes that better round quotations can be constructed. The quotations are well-structured, the capacities of the logistics service providers are used more efficiently and the percentage of sending a logistics request to the wrong provider is reduced. The logistics service providers are grouped, to compete as on contractual or, request for proposals by users. The capacity of the logistics provider deployed in the collaboration is used more efficiently, i.e., it uses its expertise in a strategic way. The profitability for logistics provider is improved within collaborative interchange, better capacity utilization and more efficient strategic implementation of logistics services.

The system sets its mark to change the way we interact with one another, through a wireless trade network connecting people and businesses through one platform.

The system acknowledges the factors affecting cargo carrier rates including: Carrier's cost; Competition with other modes of transport or other cargo carriers; Value of the merchandise; Annual volume; Size per shipment; Total cargo weight; Spring-season weight restrictions in Canada; Equipment required; Delivery requirements (many drops vs. through movement); and Possibilities of backhauling cargo.

The system calculates the chargeable weight of the shipment—the weight that the freight charge will be based upon, is generated on the formula of the shipment(s), by calculating the cwt charged by a cargo carrier.

The system processes a less-than-truckload (LTL) operation and coordination plan for small shipments from multiple exporters that are consolidated into full loads or near-full loads moving between major centres. In this operation each user pays for his portion of the truck, based on the amount of product shipped.

The system processes less-than-truckload shipments within distribution centers through a network of linehaul carriers, and it will be processed and, handled several times before arriving at destination, and therefore packaging and marking is, important to minimize the risks of damage and misrouting.

LTL rates are structured on a scale with weight breaks, i.e., the smaller the shipment, the higher the rate and the bigger the shipment, the lower the rate, and with a minimum per shipment:

L5C=less than 500 lb

### 5C=500 lb to 999 lb

### 1M=1,000 lb to 1,999 lb

### 2M=2,000 lb to 4,999 lb

### 5M=5,000 lb to 9,999 lb

### 10M=10,000 lb to 19,999 lb

### 20M=20,000 lb to 29,999 lb

### 30M=30,000 lb to 39,999 lb

40M=40,000 lb plus

The system processes the less-than-truckload scenario in the following sequence, and the overall process developed to ensure that there is end-to-end transparency: When goods are ready, the exporter provides a notification/alert to the system to embargo the carrier, for the “end of line terminal” (EOL) of a carrier. The system dispatches a local carrier to the exporter's dock to pick up the cargo. The local carrier brings the trailer to the distribution center, along with other pick-ups made. The local carrier is unloaded at the terminal and cargo is sorted and/or cross-docked according to destination. After sorting, a trailer is loaded at the carrier's distribution centre and dispatched to either another distribution center or a carrier. The linehaul driver takes the trailer to the next stop. If the haul is long, drivers must be switched at a relay point as per provincial regulations that limit the driver's time on the road. The carrier unloads the linehaul trailer and loads the city trucks for final delivery, where the consignee will unload the goods.

The system pre-books capacity in bulk with the leading multi-modal carriers to achieve a more economical rate via a consolidation service, which means selling to multiple clients happy to have their goods shipped to the same destination on the same day. Customers can specify the pick-up and delivery options such as door-to-door, airport-to-airport, door-to-airport and so on. In addition to core transport services, the freight forwarder will offer insurance, assistance with documentation and, in many parts of the world, will arrange and oversee Customs clearance. In some countries, however, licensed Customs Agents and brokers still operate independently from the forwarders and are responsible for Customs clearance of imported goods when they arrive at their destination airport or seaport. The air freight transaction is managed by the air waybill (AWB), traditionally a paper document but now moving towards an electronic system. In addition to the base price by weight or volume (the chargeable weight), additional charges that the forwarder will pass on to the shipper will include charges for export goods, airline terminal handling fees, fuel and risk surcharges, Customs data entry requirements and shipment screening under new security rules. Duties and taxes are also payable on import goods, additional to the forwarder's standard service fees.

The system serves a goal of connecting businesses with shipping intermediaries through a logistics platform. On the system, businesses can access logistics service providers to coordinate their global, domestic or local supply chain(s) in any part of the world. The system is defined as a trade network, where importers and exporters, connect on a trading platform, or as otherwise described as a “trading gateway,” to find suppliers to coordinate their international business needs. The system is built to allow importers and exporters achieve their maximum growth anywhere in the world, without trade barriers. Moreover, the system promotes a sense of creativity, helping creators, and inventors eliminate their insecurities by taking control of their supply chain and capturing their global marketplace.

The system includes seven parties involved in the movement of goods, documents and money in international trade: The exporter (Involved with the controllable the selling price, the product development, the distribution and the promotion); The importer (Providers of industrial and consumer goods to individuals and to other wholesalers and retailers, Providers of intermediate (semi-finished) goods required to complete the manufacture of the finished product, Providers of raw materials used in either semi-finished or finished products); The freight forwarder; The carrier; The customs broker (Using electronic communication, customs brokers clear goods through customs, and account for shipments, assessing duty and taxes on behalf of importers. Processing customs compliance procedures for importers and exporters for trade facilitation in member-nations in the global world.); The bank(s); the financial agency; and the credit-agency (In international trade, a major issue is that of payment to the exporter (seller) by the importer (buyer). Often, the exporter does not want to commit the goods to shipment unless it has some guarantee that payment will be made. Similarly, the importer would not wish to pay for the goods unless the importer receives some guarantee that the terms and conditions of trade are fulfilled. Often, in this dilemma a financial institution mediates the facilitation of trade. This system is designed to resolve this issue by evaluate the financial credibility of an importer or exporter, documenting and adjudicating the credit score or, credibility of an importer or exporter. The system generates volumetric reports on importers and exporters, determining their financial capability by reviewing their transactional history, and compliance review. In domestic transactions, financial institutions can conduct a credit check on an exporter's potential customers to ensure that they are financially sound. However, unlike a domestic transaction, there are many risks inherent in international transactions that can mean trouble to an exporter and increase the possibility that non-payment. As they negotiate the contract of sale, the importer and the exporter negotiate how and when payment will be made. Will a documentary collection work for both parties? Or perhaps a letter of credit is the answer. As you will discover when you study methods of international payment, banks can play a vital part of the coordinated movement of documents and money.); The government(s) (International transaction can be complete without the involvement of government, in the following possibilities: The government of the exporting country will have export-declaration requirements that may range from a simple declaration or report to a full-blown export customs declaration. If the goods are moving in-transit through a third or fourth country on their journey from exporter to importer, the governments of each of those “transit” countries will have regulations that must be met. And finally, the government of the importing nation determines customs rules and regulations on the goods that enter its country and the duties and taxes that must be paid, safety and security regulations that must be followed, data collection and delivery laws that must be obeyed.); Manufacturers; Assemblers; Processors; Manufacturing Intermediaries (The system's supply chain network encompasses supply chain intermediaries in creating a complete end-product, from designing, fabrication, assembly, processing and final-manufacturing; in all of these stages of a “product's” supply chain—input(s) are worked into a process that require numerous service providers that are distinctly, providing added-services to an end-product. It is important to build a database of intermediaries in supply chains to organically assist creator(s), inventor(s) or existing manufacturers find better links to their supply chain processes.); Trade Consultants; Engineering and Manufacturing Consultants; Supply Chain Management Consultants (The importance of trade consultants, engineers and manufacturing consultants are to develop supply chain processes and connect trade intermediaries, suppliers and service providers, in a greater initiative of building a manufacturing and procurement service within the system. The system participates in research and development (R&D) initiatives with actively developing the supply chain network with trade professionals, and sourcing plausible service providers and goods manufacturers to fit the links in the supply chain of product(s) of various industries.)

Trade Advisory Services to Importers include: Create a business plan; Ensure the user has adequate financial resources; Locate a supplier; making sure there are no trade restrictions with the supplier or its country of origin; Ensure the goods meet regulatory requirements in the domestic market; Negotiate with the seller to purchase the goods and arrange payment; Arrange insurance coverage; Depending on the terms of sale, arrange pick-up and transportation to destination; and Ensure the goods are reported to customs agencies, customs-cleared with all appropriate certificates and licenses, and accounted for with the necessary duties and taxes paid (the importer may hire a customs broker to act on his or her behalf with the member-nation's customs agency).

The system ensures that the goods they are importing will be suitable for the domestic market. In many instances, the goods and/or packaging may have to be altered to ensure that they meet various member-nation's standards and requirements, according to the customs tariff of the member-nation.

The system can do the following: Process end-to-end logistics planning according to a set-term of international trading terms, according to the global trading terms (INCOTERMS). The system allows importers and exporters to establish their global, domestic and local supply chain for product fulfillment and distribution channels. The system connects with global, domestic and local logistics service providers to process requests from businesses at all levels of distribution. Process international trade transaction(s) between importers and exporters, with financial security and safety, where contractual agreements and trading terms are maintained; Interactions between importers and exporters through an electronic exchange market, in which: Importers can process requests to purchase (buy) and Exporters can process requests to transact (sell). The system helps businesses create a process/procedure of mapping out their supply chain and interacting with the right buying or selling agent to transact their good(s) in the marketplace.

When the components for the product-specific components including the inputs of the end-product are described, via the country of origin (documentation) the system can connect other suppliers (exporters) of similar products to reduce the cost(s) of the supply chain for a member importer. Processes applicable trade information into a formal search engine for sourcing and supplying good(s) for importers and exporters, essentially reducing production costs, all the while, creating a more competitive global, domestic and local economy, forwarding an initiative of globalization. Processes customs compliance for each product, the system evaluates the product(s) component(s) and composition to retrieve the most-compliant way to facilitate trade at reduced rates in the global marketplace, and assisting, importers and exporters to participate in the global exchange marketplace. Processes customs entries with audits through the customs entries processed on the system; the documents uploaded are evaluated for compliance purposes and analysed in depth by comparing customs entries of specific HS-numbers of various importers and exporters for accuracy and generating knowledgeable background for correcting the compliance related issues with good(s) in specific countries.

The system automates applications to member-nations, processing previous trade information and data of the importer/exporter, exchanges the trade documents with customs agency/other government department(s) of select member-nations through a single-window initiative for advance rulings. The system facilitates trade by eliminating trade barriers, and allowing the maximum potential of visibility and transaction(s) from good(s) processed and exchanged on the system, for greater enhancement in the global exchange marketplace.

The system processes customs information according to the set importer/exporter, ensuring that this information is internally stored for future compliance categorized to a specific member-nation's country of import, or country of export. The goods are stored categorically, according to set: Trade documentation coded according to algorithms, where they are readable and traceable for transactional purposes (buying and selling data) in the electronic exchange market for the sourcing network. Trade information is stored according to the HS-number and, the classified according to the country of origin/importer of record or exporter of record. When the trade information is specified according to the importer or HS-number classified data about the country of origin, country of import/export can be stored for reference(s) then this information can be compared for the next importer/exporter filing for trade facilitation in a select member-nation. The trade information should be stored in the importer/exporter's file according to the products that they are importing to exporting.

The system processes trade information and data according to each HS-number/classification of good(s) according to the set country of import or export; allowing other importer(s)/exporter(s) compare trade data and information for facilitating trade in different countries. Overall, compliance measures are enhanced according to each product-classified because, customs compliance information is published and stored in the internal database of the system, according to each HS-number. This information becomes a universal data source for products that are imported/exported into member-nations, and since this information is coded according to sequential numbers (classification code) the requirements of the customs agency or other government departments in a member-nation, and this statistical information is comparable to the requirements to another member-nation.

The system allows importers and exporters to process customs clearance requests through an online portal, where they can process self-clearance requests, and declare their shipment(s) through an online interface. The system has an online customs clearance platform, where importers can declare the arrival of their good(s) at all points of entry in any country, around the world, by specifying their good(s) and uploading their clearance documents, on the online interface, and a customs broker, in the respective country, facilitates the clearance of the good(s). The importer account set-up process requires a detail on the importer. Regarding account identification information: The system establishes the user's tax i.d., importer's number/exporter's number, financial institution information, trade references, type of business, and product(s) exchanged/manufactured, # of years in service, departmental contact information.

Regarding type of good(s) being exchanged: To exchange products into the global marketplace, the type of good(s) being exchanged must be certified and up-to the standards of each country of import and, export. There are scenarios, in which, to facilitate market exploration each of the good(s) must be standardized up-to the national standards of the country of import. The importer's trade data must be verified and checked in order to open-up an account on the system, for the purpose of flagging any error in the information for trading these goods in member-nations. The importer must specify: Type of Good(s) (Documentations and standards required by each of the government and other government departments (OGDs) and customs agency's procedures involved in the transaction.); Country of Origin (The product-make, composition, components specified with the country of origin. The system seeks to understand the components involved in the making of the good(s) including all the independent “inputs” involved to create the good; Commercial Value (Transactional value for the good(s) to be exchanged, specifies the amount of exchange value(s) for the goods according to a specific quantity.); Packing Slip (The packaging of the good(s) for export or import, and how the goods are incorporated into the shipping procedure); and Bill of Lading (The set destination of where the good(s) are to be laden and processed.).

The purpose of collecting trade information is to specific and process these documents for correctness, and visibility by the importer and exporter of record, ensuring that these documents are compliant with the respective customs agencies and government departments involved in the respective transaction.

These documents will be stored into the system and revised by for compliance measures before trade is facilitated. Moreover, compliance measures will also be involved in certifying the correctness of these products with customs agencies and other government departments, prior to importation or exportation.

Type of business activity i.e. manufacturer, wholesaler, or trading company etc. Good(s) exchanged by the importer, specifying the type of good(s) that the importer purchases. Further transaction data includes purchase price of the goods, the use of the good(s) and whether the good(s) are further processed or not.

Country of Import(s): The importer will specify the countries where these goods are being traded, exchanged or sold. Selling or purchasing power of the good(s), where the existing marketplace is for the good(s) purchased. The importer may specific where the good(s) are exchanged and, where they will be transacted. Moreover, the importer describes the purchasers, for marketing purchases, which the system facilitates. These good(s) are then available in the internal marketplace, after the direct consideration of the buying and selling powers of the importer(s).

Use of good(s) for a particular purpose: The importer has the ability to specify the use of the good(s) whereas, the good(s) are specified for what trade incentive programs can be accessed in member-nations for compliance purposes, for saving on duty and taxes for specific commodities and usages.

Regarding Credit Application/Terms and Conditions of Trade: The system prepares contractual agreements between buyers and sellers for exchanging goods according to the foundational level of risks that each party (buyer/seller) to the agreement decides to agree too.

Whereas, the system connects with financial institutions, whom grant credit to the respective buyer/seller, through the platform, according to their financial assessment: Letters of Credit; granting trading conditions and product fulfillment. Cost, Insurance and Freight; the system facilitates price/cost estimations of the good(s) according to the service expenses of global, domestic and local shipping

The system grants the importer and exporter credit terms and conditions for payable(s) on the total cost of shipping including duty and taxes, if agreed to be fulfilled by the system. These terms/conditions are determined based on the freight expenses and the credit-terms are applicable on the duty/tariffs on the import(s).

The system has certain terms/conditions for using and accessing information on the platform and therefore, the system has a contractual agreement between the importer/exporter and the general system and its entities, involved on the service platform. Terms/conditions are based on the accessibility and usage of information that is shared, stored or, processed on the system.

The system sets-up direct connections between a country's customs agency, and the importer/exporter of record, and, the importer/exporter will be provided an account security number for the direct transmission of duty/taxes to the country of import. In addition, the system stores the trade information pertaining to the respective country of import, and it processes the trade data and information with approval from the respective country of import.

The system initiates standard trading conditions between the respective importer/exporter and the licensed customs brokers in the member-nations, this includes: Service fees (charged by the customs broker) and disbursements (monies paid by the customs broker on behalf of the importer/exporter); Invoices (how issued) and payment (when due); Advancement of funds (duties and taxes may need to be advanced from the client prior to releasing goods); Duties and responsibilities of the client, such as: advising of errors within a specific time frame; Reimbursing the customs broker, and indemnifying the customs broker from all demands resulting from inaccurate information provided by the client; Duties and responsibilities of the customs broker, such as providing services in a timely manner; Keeping any client information confidential, and providing the client with copies of transactions and/or proof of duty payment; Errors and omissions (errors or omissions on data transmission must be reported to the customs broker in a specified number of days); Termination (if an GAA is terminated and there are outstanding matters, the GAA will remain in force until the outstanding matters are concluded); Law (the STCs are governed by the laws of the province in which the customs broker has his principal place of business); and Severability (each item in the STC is separate. This means if one is not valid or enforceable, the others are not affected).

The system has a network of logistics service providers, on global, domestic and local levels of all the member-nations that trade is facilitated. The purpose of the network is to bring on reputable service providers, who are set-up in the system to enhance the logistics service portfolio of importers and exporters, allowing them to feel safe and secure when trade is facilitated through the platform.

To ensure compliance, customs agencies require information regarding exported/imported goods and about the exporter/importer himself. The system informs the client of any requirements for imported goods, such as import permits or restrictions, i.e.—any new, revised, and rescinded regulations.

The system has a thorough knowledge and understanding of the products and nature of the exporter's/importer's business, the end-use of imported goods, since the amount of duties can depend on their end-use.

In addition, the system performs other functions such as the processing of duty refunds, requesting a re-determination of tariff classification or the value for duty, applying for duty relief or providing trade advisory services.

The system is also required to work within the transportation community, to the extent to which the system is involved with such tasks as securing steamship releases, surrendering original bills of lading, accepting and delivering customs releases, preparing and issuing delivery orders, and paying freight, handling, or delivery charges, depends on the regional and local practices of transportation companies and their cargo agents.

The system provides: Importers and exporters with a copy of the customs accounting document prepared on their behalf (either a hard copy document or copy of information transmitted via EDI); Advises clients of any funds received for that client from the Receiver General for Canada; Advises clients of any funds received from that client that are more than any duties payable; and Advises clients of any funds received from that client that are more than charges payable regarding that client's business with customs agencies in member-nations.

Customs brokers must keep copies of: Records and books of financial transactions while acting as a customs broker; Each accounting document or a copy of information transmitted to CBSA via EDI; All supporting documentation; and Records, accounts, and accounting documents while acting as a sub-agent.

The system maintain records, according to the Imported Goods Records Regulations, of member-nations via EDI. If the exporter/importer does not have an office in respective member-nation, a licensed customs broker, accountant, or other authorized responsible agent may be appointed by the exporter/importer to maintain such records on his behalf, with the understanding that it is an obligation under the Customs Act that these records be kept. Customs agencies will permit an exporter/importer to keep records at specific locations outside of the member-nation if they meet specific conditions. On behalf of the importer, the system contacts the customs agency for permission.

The system facilitates trade for importers and exporters through general agency agreements (GAA) which impose standard trading conditions indicating what the system will do, on behalf of the respective importer/exporter. A written agreement is required before a customs broker may act on behalf of a client; the licensed customs broker may be required by the member-nation's customs agency to provide a copy of this agreement. A memorandum in the respective member-nation outlines the format of the GAA.

The system acts as a third-party between a respective business and a licensed customs broker (sub-agents); allowing for release of goods, paying duty/taxes, preparing documents for import or export, and arranging for the storage of goods. Whereas, a sub-agent is a licensed customs broker who has been appointed by one customs broker to act on their behalf at a port where the appointing customs broker does not have a licence. The system uses EDI (Electronic Data Interchange) to send information directly to the licensed customs broker in the member-nation, which allows transmission of information directly to the member-nation's customs agency, regardless of where they, or the goods, are located. The ways in which, competent trade services are provided are through the system's operating procedure which ensures that its respective users are given compliant service.

The system provides the importers/exporters with set credit terms and limits for transacting commercial business with the respective importer and exporter. Whereas, the system reimburses the customs broker for its service, and the credit limits are granted by the system to the respective importer/exporter. Therefore, the system posts security for the importer/exporter, and the customs broker is acting on behalf of the system. The system appoints multiple customs brokers in respective member-nations to transact on behalf of importers/exporters.

The system processes end-to-end logistics service requests, in which, a shipment is to travel from a point of origin to a destination, through a multi-modal simulation, in which, the origin to destination, are categorized via the mode(s) of transportation, by which, a select shipment(s) can be transported. The variables in deciding which mode of transportation is most applicable, are based on: Origin and Destination; Mode of Transportation; Commodity Description—dimensions (lwh) and weight; Transit Time—estimated arrival times; Cost Analysis; Service Capacity and Equipment Type(s)

The system processes end-to-end logistics services, via phases and components of logistics, in which the request is segmented into different fragments of logistics service, and the select phase(s) require different logistics service providers to service the phases, on a global, domestic and local scale for example: Loading at the exporter's premise; Domestic pre-carriage/local cartage; Contract of carriage and dispatch; Trade documentation in country of exportation; Customs clearance in country of exportation; Export charges; Loading at cargo carrier's terminal; Transportation equipment and accessories; Transport (cargo) insurance; International main carriage; Unloading at terminal; Trade documentation in country of transit/importation; Import charges; Local cartage/domestic on-carriage; Unloading at buyer's premises; and Other Charges

The system processes a logistics service request through its Cargo Portal Services from origin to destination, based on the above-noted segment(s) and phase(s) of service, in which, logistics service providers provide service proposal are interlinked to create a collaborative service proposal. Depending on the type of carriage(s)—mode(s) of transportation, and the phase(s) involved from origin to destination, the logistics service request(s) will change accordingly, the steps in sourcing the logistics service provider(s) will shift, for processing an accurate quotation.

The system processes commodities into 18 classes, from a score-rating of class 50 to a high of class 500, in which classes represent very dense freight that is not prone to damage and easy to handle, as well as heavy and cheap items (e.g., bricks, roller bearings, etc.). Conversely, higher classes represent lighter, less dense freight that typically takes up more space, as well as light and expensive goods (e.g., feathers, automobile body parts, etc.).

The system processes the origin and destination service request(s) by route planning and coordinating the mode(s) of transportation that fit-into the origin and destination the system services. Therefore, in the initial phases: The system processes the geographical ranges of logistics, by calculating the routing option(s); and the mode(s) of transportation(s) available for each “trade lane(s)”. (Calculates the transit times, and configures the mode(s) of transportation). Next, the system connects these routing option(s) to mode(s) of transportation(s) by sourcing logistics service provider(s) who provide service the different phase(s)/segment(s) of logistics required in the service request. (The system interlinks cargo carriers for the select option(s) of logistics service processed for request). The system processes a quotation, after the logistics service request is completed, with the various phase(s) and segment(s) of service assumed for each multi-modal service in the select origin and destination.

The system processes logistics service providers, according to a set registration process toggled by the system. This registration process involves a database of the logistics service provider's most applicable services in logistics, in which, a logistics service provider, specifies their service capacity in distinct areas (i.e. areas of speciality, including equipment type(s), number of operators, lanes of service, commodities handled, etc.); a detailed registration process pertains to the importer and exporter's requirements for logistics service.

The system processes this information into an internal database for purposes of handling a request for quotation, and proposal for logistics service; when, the request(s) for quotation are received, they are filtered according to the criteria of the set inquiry by the user, and the fields of inquiry, are then automated, to match the logistics service providers; and then, complied to be transferred into a formal request for quotation, provided to the user. The purpose of a quotation is to process the logistics service, quotation requests into many different simulative possibilities of re-working multi-modal transportation services to its fullest scale of potentialities.

The user requests for a quotation, by specifying: INCOTERMS® 2010, Terms and Conditions; Origin and Destination (address, city, state, zip-code); Expected Transit Time (dd-mm-yyy); Commodity Description (dimensions (length, width and height), weight (lbs, kg), number of pieces and special handling instructions); Shipment size (less-than-truckload or, full-truckload) (number of pieces) [cargo details per, piece(s)]; Type of Equipment Required, and Special Instructions; Commercial Value (liability, insurance and valuation)

The system processes front-end requests by the user's, according to the scale of tranit time(s) provided by multi-modal transportation source(s), the origin and destination, and the availability of the logistics service(s) requested according the variables inputted by the user. The variabilities are based on the cargo carrier(s) capacity, and ability to provide logistics service for a designated request. The logistics service provider(s) information is algorithmically inputted into the system, linking to the variable factors that effect a request for logistics service.

The system processes the request for quotation(s) from the user and examines the possibilities of the logistics service that can be processed for a request. The system processes a service request based on the origin and destination, calculating the expected time of arrival, via different mode(s) of transportation service(s). The system calculates transit time via air, as an expedited transportation service, nonetheless, the variabilities of factors are the cargo carriers who service a particular lane (origin to destination), and based on that, the routing information of each cargo carrier is determined.

The system processes origin(s) and destination(s) to devise a logistics plan for users and ensuring that competitive logistics service provider(s) are available and able, to provide designated service for users. The system processes this information to ensure that independent and dependent variable(s) are processed in a technical manner, in order to be controllable over the course of developing the logistics service system.

The system simulates lanes of service, based on the multi-modal cargo carriers operating specific trade lane(s), by generating a classified code(s) based on the logistics service providers, servicing particular lane(s), types of commodities and, and equipment type(s). To automate the process, the system processes the information of multi-modal cargo carriers, based on: Processing multi-modal cargo carriers, into standardized code(s) which allows the system to read the request, according to lanes of service origin(s) and destination(s): Tariff schedule (rate schedule); Routing schedule (layovers etc.); Transit times (schedules of expected arrivals); Loading, departure, lay-over, and landing (schedules); Equipment type(s) [i.e. vessel(s), aircraft(s), trailer(s), or, railcar(s)] and, availability of each type of equipment(s); and Commodities handled—dimensions, weight and special instructions [i.e. hazardous, project cargo, or, classified good(s)].

The system processes the origin(s) and destination(s) according to various mode(s) of transportation, and therefore, these multi-modal transportation services must be logistically planned according to the routing instructions, and different possibilities of reaching the end-destination, through different routing patterns, considering that end-to-end logistics service means, that a global logistics service request requires multi-modal transportation, for an extended supply chain solution to circumvent.

The system processes route planning for each lane of service, according to the various mode(s) of transportation required to execute a logistics service request, in which, different simulations of routing from a point of origin to an end-destination are pre-determined by the system for simulative purposes. The system processes trade lanes according to the various routing option(s) available, and therefore, the system connects multi-modal service providers to the phases of the routing plan.

The system processes variable factor(s) into different simulation phases, whereas, different service capacities based on origin(s) and destination(s) are categorized into, phases of transportation service, to combine multi-modal service, to an end-destination. The system processes an origin and destination according to route planning options, which are based on the different phases of logistics service required to complete a logistics service request. The system generates phase(s) of logistics from origin to destination, into variables of service, phasing logistics service request(s) into components of stages from local, domestic to global stages: The system accumulates variable factor(s) of logistics service to be processed distinctly by each multi-modal service provider on the system, which includes, various components for

The system interconnects the front-end (user) to the back-end (logistics service provider) to link their service request(s) with the various possibilities of multi-modal service providers to process particular logistics service request(s). The system processes logistics service requests from user(s), by requesting from the user(s) all the variable factor(s) that effect a logistics service request, in which, the inputs to the logistics service request are provided by user. The system processes logistics service providers, according to the mode of transportation serviced, and selected the database accumulates information based on the commodity, transit, and type of service. The information inputted into the database is codified, into an algorithm to interlink the service request(s) to the logistic(s) service providers.

The system processes information of logistics service providers into an internal database, by surveying from logistics service providers variable factor(s) that effect a request, and processing response-information to a logistics service request from a user. The system processes logistics service request(s) based on information that transfers into algorithms: Lanes of service [origin to destination]; Transit times [i.e. estimated times of arrival]; Commodity code(s) [selected], dimensions, weight and special attributes; Equipment type(s) [i.e. vessel(s), aircraft(s), railcar(s), trailer(s)]; and Capacity of service(s) [i.e. volume of equipment and availability]

The system interlinks the information retrieved through the front-end user to the back-end logistics service provider by linking the service request, to a logistics solution, with multi-modal possibilities of logistics service for a request(s).

The system processes the service request into phase(s) and segment(s), and concludes with an internally generated rate quotation, and proposes this to the user, with different variabilities of service, on the mode(s) of transportation provided, which alter the transit time for the select trade lane.

The system processes the routing information based on the legislative environment between member-nations serviced on the system, this includes, the rules and regulations enacted in and between member-nations, regarding: Licensing, equipment, weight and dimensions, speed limits, taxes, insurance, tariffs, labour issues such as wages and training, liability, vehicle and driver safety, hours of service, daily trip reporting, maintenance standards, carrier record keeping, roadside inspections and others; Maximum dimension(s) of commodities, weight requirements for commercial vehicles; and Traffic control, multi-modal cargo information, weather briefings, advisory services, aeronautical information services, and electronic aids to navigation.

The system processes a global positioning system (GPS) for all mode(s) of transportation, in which, air, ocean, rail and road transportation are calculated based on the travel routes, legally approved by member-nations, and in the global, unprotected territories government by member-nations of larger world-organizations. The system processes the geographical routes of multi-modal service, according the developed routes that carriers are allowed to travel on the global, domestic and local scale of activity—this includes: Routing for traffic in all the member-nations, including the routes allowed for associations and government organizations (i.e. NAV Canada).

The system processes the routing options via global positioning systems, and matches them with the route(s) of the multi-modal carrier(s) (via—air, ocean, rail or road), interlinking the process of “how” carriage will be processed, and what routes the carriers will assume to the end-destination.

The system processes the network of multi-modal transportation by consulting with the legislative frameworks, and regulations related to global, domestic and local transportation services in the various domains across the world. The predominant legislative framework is governed by large-scale, quasi-bodies or, independent governments, from whom the system can create caches, and clauses to the transportation services provided through the system.

The system processes the hub(s) and distribution network(s) of multi-modal transportation provider(s) according to their set location, and operations unit, this is usually determined based on the locality for the origin and destination point(s), essentially where the multi-modal transportation service(s) are required—for on-loading and off-loading.

In addition, for select mode(s) of transportation (i.e. air and ocean) the ports of lading are provided with geographical pin-points on the routing map/configuration determining where the nearest location for a transportation inquiry is most applicable.

The system processes an indication for respective customs agencies in member-nations, for foreign customs clearance in member-nations, as well. The system provides an operations grid for good(s) from the point of origin and destination, allowing logistics service providers to track and trace shipment(s) at all points of the carriage.

The system processes these respective locations, according to code(s) i.e. the identification number for customs agencies in member-nations, airport(s) and locations of multi-modal transportation providers, allowing logistics service providers and user(s) to see a map of the port(s), processing point(s), and facilities on a updated, live map.

The Quotation Process is as follows:
1. The exporter and importer agree to a set of financial terms and conditions, for the processing of good(s), from origin to destination, and based on the international trading terms and conditions, a quotation for logistics service is generated.
   a. Cargo Insurance Specification
   b. Freight and Demurrage Charges
   c. Cargo Handling and Port Charges
2. The exporter specifies the request for quotation with shipment details, including:
   a. Origin and Destination (Address, City, State, Postal Code) [Codified]
   b. Commodity Description (Harmonization Code, Commodity Code, NAICS Code(s)) (Dimensions, Weight, Number of Pieces and Loading Description)
      i. Dimensions of select shipment(s)
   c. Commercial Value (Class of Good(s))
   d. Cargo Insurance(s) (Multi-modal)
   e. Expected Transit Times (Expedited, Regular, etc.)
3. The system calculates the quote based on the shipment details, and in accordance with a route plan—geographical analysis, and the multi-modal carriers involved in the logistics process.
4. The cargo carriers provide a rate quotation, and an end-to-end quotation is generated, with the specifics of the logistics service, in which:
   a. Cargo carriers, and space is booked according to availability
   b. Route planning, permits and special instructions are assumed, and an assessment for transit time(s) are planned for appointments/schedules
   c. Estimated time of arrival is confirmed based on the transit time
5. The system processes the shipping documentation:
   a. Commercial, Financial, Transportation and Customs Documents
   b. The carrier assigns a cargo control document, for import and export declaration(s).
6. The exporter and importer confirm the documentation(s) and the set schedule starts for carriage.
   a. The goods are picked-up from the exporter's location (origin) and the process according to the mode(s) of transportation(s) selected are processed
   b. The documents are exchanged and processed, for full-transparency
7. The logistics process shows complete visibility, documents are exchanged; notifications and alerts are processed, and cargo carriers provide tracing updates throughout the process.
8. The cargo clear customs, and the final invoice and accounting information are generated.

The system processes commodities according to the class of the good(s) from 50-800, specified through a classification system, highlighting which commodities are of high-value or, low-value.

The system classifies commodities with industries, and industries are processed through the NAICS codes (North American Classification System) and, others, depending on the regionality (i.e. European; NACE) there are different nomenclatures, which vary based on the origin of the good(s), and they automatically adjust according to the select origin.

The system processes cargo handling instructions according to the commodities selected via the commodity code(s), and the classified industry pertaining to the commodity.

The system provides a procedure of handling commodities to the user at the (front-end) for research purposes for cargo handling instructions and at the (back-end) for logistics service providers for cargo handling and processing instructions for carriage, and transference.

The system provides a cargo handling manual, for each good(s) according to their HS-number and description, as well as, the mode of transportation(s) processed for the commodity; acceptable according to the member-nation's rules and regulations of safe cargo handling.

The system processes an Accounts Settlement System which simplifies reporting of cargo sales and settling of accounts between logistics service providers and users.

The system organizes export and import accounts into two independent systems that can be implemented either separately or together on a country-by-country basis. The system proves central reporting and invoice production through the account settlement system providing advantages to both cargo carriers and users:
Standardization of cargo procedures and forms;
Production of industry-standard invoices;
Simplification of remittance: users pay one amount, and the system settles payments covering carriers; carriers receive one amount covering payment from user(s);
Elimination of duplication of data entry; users and carriers using their own system may deliver or receive sales and standard invoice information in electronically readable form;
Centralization of error handling;
Handling of remittance irregularities conducted impartially, using standard rules;
Enhancement of financial control and improvement of cash flow;
Provision of reliable and up-to-date sales statistics;

The system processes logistics service provider's documentation for (all) logistics request(s) with three (3) types of documentation as follows:

1. Transportation documentation;

2. Customs documentations;

3. Commercial documentation; and

4. Financial documentation.

The system processes documentations of trade according to the type(s) of transaction(s) of logistics initiated on the system, and the logistics service providers segmented in each phase of the service process. The system processes these documents through an electronic data interchange (EDI) support capability, which is transferrable and outputted through a electronic, tablet-device, or smartphone device, that allows the documents to remain on the mainframe of the system, and process a solid end-to-end totally transparent and visible logistics service.

The system processes transportation documents on the main-frame of the system, i.e. bill of lading issued by the carrier serve as the receipt for the goods, a contract of carriage and, in some cases, for ocean freight, a transferable title of ownership. (i.e. rail bill of lading, overland bill of lading, marine bill of lading for ocean freight, multimodal bill of lading covering the whole voyage e.g., via marine and rail modes, and the air waybill for air freight).

The system processes other documents can be issued by carriers, freight forwarders and other relevant parties over the voyage include:
Booking confirmation: issued by carriers to confirm the arrangements made ahead of the shipment.
Dock receipt: confirmation receipt of goods at a dock or a warehouse.
Transit documents (forms A8A in Canada, T&E in the U.S., T1 in Europe): to allow shipments to move in bond beyond the customs port/airport/terminal/border crossing of first arrival.
Advice note: logistic service providers issue this on arrival at destination to notify the consignee and for customs clearance.

The system processes customs documents according to the harmonization-number and commodity code(s) of the good(s) exchanged between the importer(s) and exporter(s), in which documents are generated according the select commodity, which are classified according to the export and import guidelines of the member-nations.

The system processes customs clearance documents according to the commodity code(s) and harmonization number(s):
1. The export declaration (not required for exports in specific member-nations unless the goods are controlled, prohibited or regulated);
2. The customs bond;
3. The post-release customs entry (form B3 in Canada and form CBP7501 in the U.S.);
4. The export/import permits;
5. The ATA carnet;
6. The consular invoices;
7. The certificate of inspection, the certificate of analysis, as required by either or both, the country of import and the country of export.

The system processes import documentation required in the country of destination, i.e. for an overseas cargo carrier, freight forwarder, and advise the importer(s) and exporter(s) accordingly. The commercial documents required for export and import are generally processed via the system and are as follows:
1. The packing list is a detailed list of contents of the shipment that is essential as a supporting document in case of a possible insurance claim.
2. A pro-forma invoice is sometimes required to confirm the order before shipping and to enable the importer to apply for an import licence or a letter of credit.
3. The commercial invoice documents what the buyer must pay the seller and provides information to the countries of export, import and transit.
4. The certificate of origin certifies the origin of the merchandise. For example, to obtain the NAFTA benefits, a NAFTA Certificate of Origin is required.

The system processes financial documents according to the international trading terms and conditions of the contract between the exporter and the importer and the method of payment agreed to (e.g., open account, advance payment, documentary credit or documentary collections), financial documents required include, the letter of credit advice and confirmation, the draft, the promissory note, the bill of exchange, as required by financial institutions. The commercial invoice is also a financial document, as it is the document against which the buyer and/or the bank will issue the payment.

The system uses the Incoterms to make a sales contract, according to the goods; the means of transport; and, where the seller and buyer agree to transfer risk and cost. The contact refers to a geographical “named place,” where the cost(s) and risk(s) are transferred, clearly defining the rights, responsibilities and obligations of the exporter and importer in the transaction, relating to security-related clearances, such as chain-of-custody information, written according to: Provision of goods in conformity of contract, payment of price; Licences, authorizations and formalities (clearing goods for export or import); Contract of carriage and insurance; Transfer of risks; Division of costs; Proof of delivery, transport documentation, or equivalent electronic transfer; Inspection of goods: checking, packaging, and marking in accordance with contract; and Other obligations.

The system bases the generalities of trading terms on group(s) for sales contracting, relating to the general obligations of the exporter and importer, licenses, authorizations, security clearances and other formalities, contracts of carriage and insurance.

The system simulates the cost(s) according to the responsibilities of the importer(s) and exporter(s) according the stage(s) of the logistics service process, divided based on the importer(s) and exporter(s).

The system selects the “rules for any mode/mode(s) of transport,” and simulates the invoice(s) according to the responsibilities at each stage of the logistics process for the importer(s) and exporter(s), the following represent the cost(s) break-down in the international trading term(s) and conditions: Loading at the seller's premise, Domestic pre-carriage/local cartage, Contract of carriage and dispatch, Trade documentation in country of exportation, Customs clearance in country of exportation, Export charges, Loading at carrier's terminal, Transportation equipment and accessories, Transport (cargo) insurance, International main carriage, Unloading at terminal, Trade documentation in country of transit/importation, Import charges, Local cartage/domestic on-carriage, Unloading at buyer's premises, and Other Charges.

The system integrates the INCOTERMS below, advising the importer(s) and exporter(s) of the shipping quotation(s) for every stage of the logistics process, according to their level of responsibility.

The system is a customs brokerage network operating as an international trade platform which systematically expedites the clearance of international cargo with customs agencies in global nations, and deals with the problems of customs compliance encountered by importers and exporters, the industrial and trading community with customs agencies in global nations where service is provided on the system. There is an expanding need to revise and update customs administration procedures for the international business community. This software is designed to interconnect member-nation's customs agencies through a technological advancement, where international businesses can declare, monitor and comply with member-nation's customs rules and regulations on a single interface, virtually declaring their goods with customs agencies anywhere in the world.

This is a very simple system achieving rapid clearance with minimal cost. Customs agency function in any country is one of exercising government controls on the importation and exportation of goods. These controls are not just for collection of revenue and protection of local industry but for many other purposes. For example, the control of dangerous goods and the alerting of authorities for agricultural inspection. The system's objective is to exercise these controls efficiently with minimal costs and minimal delay in the delivery of goods.
1. The system is designed to resolve customs problems based on purely technical considerations
2. The system is to improve and harmonize customs procedures and thus promote the development of international trade.
3. The system studies the problems which arise in international trade and drafts internal checks and balances by recommending businesses, the industrial and trading community recommendations or courses of action for improving trade.
4. The system is design to be open for adoption by all nations, and their shipping intermediaries.
5. The system assumes an active role in expediting the clearance of international cargo through customs.
6. The system is designed to facilitate trade by removing trade barriers that exist between member-nations, it does so, by providing processes of “how-to” import goods into member-nations, prepare customs documents, and prepare importers and exporters for random customs compliance issues flagged by customs agencies.
7. The system reduces trade barriers by pre-clearance of cargo at ports of export, the possibility of combining import and export documentation between countries, the potential of compatible computer systems recommending and the possibility of a harmonized commodity code system which would rationalise the coding systems used by various parts of the industry to identify commodities.

The system is designed to work with international organizations, individual member-states, to further its policy of facilitating the flow of cargo in international trade. The system is designed for the private sector, in which a society of customs brokers exist to facilitate trade in the international community, through a single web-interface. Further, the system is designed to harmonize customs procedures worldwide by converting international conventions into a technological process, coded to assist the international business community remain in compliance with national customs rules and regulations in the nations where they are importing or exporting too.

The purpose of the system is to facilitate trade by providing businesses with a means of carrying out essential customs procedures without creating errors or delays in their profile with foreign governments.

Its protection covers a business for a stated period of time, in contrast to the guarantee required in international customs procedures under the usual carnet system.

The system also strives to promote closer cooperation between the customs administrations of trading nations and to facilitate the flow of merchandise through the use of recommendations drafted by its software. The system is not short of:
Mutual administrative assistance in facilitating trade in new markets i.e. nations
Pooling of information concerning customs fraud
Exchange of information concerning illicit traffic in narcotic drugs
Repayment or remission of duties on goods refused by the importer as not conforming to contract
Refund of import duties and taxes on shortages
Adoption of a layout key for the goods declaration and,
Customs sealing systems in connection with the international transport of goods.

The system also seeks to promote the flow of international trade by suggesting certain courses of action to be followed by businesses when dealing with customs administrations, as well as the preparation of International Customs Norms which deal with specific points of customs technique and constitute guidance for customs administrations considering amending their legislation or regulations.

The system's features the Harmonized Commodity Description and Coding System for International Trade, which is the uniform commodity description code has long been recognized by various international organizations, such as the Economic Commission for Europe, the United Nations Conference on Trade and Development, and the International Air Transport Association.

The system also facilitates a number of programs on a purely national scale which facilitate the movement of cargo to and through customs control. Containers may be transported from the place of arrival to a container station and there unladen and unpacked.

The system simulates its process and overall design, by recognizing the different use(s) of products and, collects information about the importer/exporter's intended purpose(s) for importing/exporting the specific product and frame this information in a supply chain grid, for product-development and information for future inventors and creators; the customs action plan is created for a specific user:
This means that the processes described, are intended to be converted into the overall system's design and implementation for a proper working software; implementing the customs clearance information to an overall supply/sourcing channel.
The variable(s) in the method of the program are based on designing a customs action plan, where there is complete transparency between the importer/exporter and the system for customs compliance. Some of the information stored into the system are:
   The use of the specific product (i.e. temporary import, processing or manufacturing)
   The country of origin (i.e. tariff treatment assigned)
   Cost of production (i.e. the components and element(s) used in the product)

The system is designed in a simulative-spec, meaning, when specific information is inputted into the required field(s) of documentation, other steps/information related to further compliance are shown, in order for the importer/exporter to increase their transparency with the respective customs agency in the member-nation.

The system features components designed to protect businesses from errors in the customs administration processes through a network of customs brokers in member-nations in the global world.

The system built its audit-proof customs compliance software through the law(s), act(s), legislation(s) and penalties relating to the non-compliance in customs procedures in member-nations.

The primary method of deterring from compliance-related audit problems, are to build an importer/exporter's compliance measures in direct relation to the administrative monetary penalty system (AMPS) which apply to the licensing of customs brokers and the respective importer or exporter, that are assessed in the failure/non-compliance with customs procedures. Therefore, the system is attentive on the administrative penalties pertaining to shipment(s) and ensures that errors and omissions related to non-compliance are enforced prior to export/import.

The system enforces compliance measures according to the: Customs Act—importation and exportation of goods into and out of member-nation. It identifies the powers and duties of customs agency officers and provides the authority for the collection of customs duty/taxes. It also enforces all of the adjacent acts of customs authorities including the enforcement of the Customs Tariff or the Special Import Measures Act.

The system allows the owner of the goods to account for and pay the duty/taxes pertaining to the import, and a licensed customs broker to transact the import on behalf of the importer/exporter.

The system provides transparency by allowing importers and exporters to control their transactions with customs agencies in member-nations, since the importer is ultimately responsible for any declarations made to the customs agencies by a customs broker, on their behalf. Therefore, complete transparency and visibility of their transaction is made available via the system.

The system posts security for the good(s) transacted on behalf of the importer/exporter, after applicable credit-checks are made, unless, other compliance measures (i.e. account security numbers, or tax-direct) are arranged with customs agencies.

The system has a server that stores the information pertaining to imports/exports transacted for a period of six years after the importation of the goods to which the information of the shipment relates and that this shall be kept in such a manner as to enable an officer to perform detailed audits and to obtain or verify the information, kept in a copy made by means of any photographic, microphotographic or image-processing process that is in accordance with National Standard of Canada CAN/CGSB-72.11-93, and are supported by a system capable of producing accessible and readable copy.

The system contains a global database of the customs tariff pertaining to the member-nations, apart of the World Customs Organization, classified according to the harmonized system, containing the tariff treatments for each respective commodity group. The system uses the general interpretative rules (GIRs) to classify goods in the harmonized system, which govern the classification of goods according to the legal notes, phrases, terms and punctuation used throughout the tariff.

The system holds the complete database of the harmonized system of tariff classification that was developed by the World Customs Organization featuring 5000 commodity groups and is used by more than 200 countries as a basis of international trade statistics.

The system processes this data exchange for importers and brokers to prepare and file B3 final accounting documents electronically with customs agencies. Participants are able to receive automated K84 daily notices and monthly statements, tariff and exchange rate file updates as well as notifications of release and overdue releases.

The system supports release providing importers and customs brokers with the ability to transmit release and invoice data in an electronic format, with other government departments (i.e. Canadian Food Inspection Agency, Transport Canada, Industry Canada and Natural Resources Canada) of whom release transactions are processed.

The system follows the approach of the G7 EDI Export Reporting process which was developed in order to facilitate the import and export of goods between the G7 countries. The system is designed to provide technical information to users of global member-nations apart of the WTO.

The Release Notification System (RNS) service offers timely and efficient notification of release decisions made by customs agencies by providing importers, customs brokers, warehouse operators and cargo carriers with EDI RNS messages.

The system interconnects users, customs agencies, other government departments, and logistics service providers with data integration, technical and systems information related to the Electronic Data Interchange (EDI) transmission of the IID and the Web Service transmission of LPCO (Licence, Permit, Certificate and Other) images.

The system processes release requests on release with minimum documents (RMD) and are processed according to the mode of transportation.

The system processes the release online, and scans the release package for syntax errors, the exporter prepares the usual customs invoices and any other required documents for the goods being shipped, and the exporting carrier arrives to pick up the goods at the exporter's premises, and the carrier affixes a PARS bar-code to the top right-hand corner of the original invoice, electronically. The driver will take the original bar-coded invoice with him, plus one copy for use as a delivery receipt.

The system transmits this information concerning the goods by the exporter or the carrier to the importer and customs broker. This information processed electronically on the system and includes a copy of the bar coded customs invoice.

The system will also display the status is “release”, the officer updates their customs agency software to show the arrival of the goods, date stamps and retains the original invoice.

The system prepares the customs release documentation according to the rules and regulations of a member-nation, where the good(s) are imported. The system divides up the customs procedure into three phases pre-entry, release and post-entry services, all of which provide distinct services for customs processing and planning. According to each member-nation, a template of the documents required, are uploaded/generated by the respective customs broker, appointed by the system. The system ensures that compliance is maintained because of its standard operating procedure in each member-nation, and the transparency in the customs procedure.

The system accesses the release process by creating original document(s) through the system, which includes the bill of lading, commercial invoice, certificate of origin, and packing slip(s). The system ensures that full-compliance is met, with authentic documents produced through the system, prior to making a customs declaration.

The system processes release requests via marine, air, highway and rail shipment(s) being imported or exported into member-nations. The system's technique is for the importer or exporter to control its supply chain with complete transparency and visibility of their goods in motion.

The system ensures the licensed customs brokers on the system, are posting security before the release of goods, this security is guarantee that the duty/taxes will be paid. The system recommends to importers to have their own account security number, and security posted with respective customs agencies for security purposes and accountability of their duty/taxes. The system also sets-up GST-direct letters/statement of accounts for importers with the respective customs agency in the member nation for the purpose of accounting for goods.

The system calculates a value for duty which is required for all goods imported into member-nations, the method by which the value for duty has an impact on how much duty and/or tax is paid, users need to know what costs may be added to or deducted from the price paid for the goods.

The system provides customs agencies with electronic pre-arrival information. This allows them to identify health, safety and security threats related to commercial goods, before the goods arrive in member-nations.

The system allows the transmission of conveyance and cargo data electronically to customs agencies, through a single window interface, where the conveyance data is information about the truck, ship, plane or train that is carrying the goods and cargo data is information about the goods they are carrying, the description of this system is provided in the system's functionalities, known as the e-manifest.

The system is built around the different the customs agencies of member-nations where customs declarations are connected to each member-nation's customs agency through a single window interface.

The system acknowledges highway as eManifest. In all modes, the carrier is responsible for transmitting conveyance data and cargo data; and the system does the integration.

The system processes accounting for high value shipments, (those valued at more than $2,500) presented in hard copy or transmitted electronically and accepted by customs agencies within five business days of the date the goods were released. The accounting period starts on the first business day after the release date.

The system guides the importers on how to create as an online accounting document according the rules and set procedures of completing the accounting form, self-check without any errors and omissions, and it is processed through the proprietary system of the customs agency i.e. CADEX for Canada Customs.

The system makes available the final accounting, when customs agencies issue Daily Notices (DNs) and a monthly Statement of Account (SOA).

The system creates ARL combining DN (Daily Notices) and SOA (Statements of Account) that combine multiple transaction types into one statement. These statements contain information about B3s filed, payments made, interest owing, and refunds issued, among other debits and credits.

The system, on the 25th day of each month, customs agencies issue a SOA to approved account security holders. The SOA includes the total amount of debits and credits for the preceding payment period. The amount owing for each importer account shown on a customs broker SOA is a net of the debits and credits associated with that importer's Business Number.

The system integrates compliance allowing importers to reach decisions in terms of valuation, classification, and origin. The system demonstrates that the importer has measures in place to ensure that the accounting information is accurate from the source data.

The compliance system includes all relevant information from customs agencies that lead the importer to a particular decision, and should include any Customs rulings, notices or policies that apply. It is the back up to what leads to creating a final accounting document.

The system processes self-audits to identify a changed condition that impacts valuation or origin, a clerical error, or a misapplication of a tariff treatment that can provide the opportunity for correction, and even limits the exposure to the error. A self audit can be used to demonstrate “reason to believe”, a key component in limiting escalation or correction periods of penalties.

The system's compliance measures are built to be responsive of:
Providing advice on tariff classification, value for duty, and any other relevant federal or state-level requirements.
Ensuring that the importer understands their obligations and liabilities under the Customs Act, Customs Tariff Act and Excise Tax Acts in Member-nations.
Educating about AMPS and the true cost of non-compliance.
Providing advice concerning refunds, drawbacks, and remissions.
Appealing customs agencies decisions on tariff, value, or origin.
Providing advice and assistance pertaining to penalties.
Advising of the requirements of Other Government Departments.
Assisting in the development of compliance program manuals.
Performing an audit and identifying potential weaknesses in the compliance program.
Developing and/or maintaining a database using SKU (Stock Keeping Unit, or usually included in a bar-code) level detail in relation to tariff classification.
Providing notification of changes to customs agencies policies that may impact the client.
Providing advice on security related programs or audit existing programs, such as PIP and C-TPAT).
Providing or suggesting compliance training for staff.

The system advises importers who are eligible to apply to the CSA program and assist them with meeting these requirements if:
they are residents of Canada or the United States;
they have a history of actively importing for at least 90 days;
they do not have a history of contraband or major commercial infractions;
they are prepared to make an investment in business systems; and
they are willing to provide senior management authorization that their books and records contain
or will contain commercial business processes, customs interfaces and internal control procedures.

If an importer wishes to take advantage of the streamlined entry process under CSA, all carriers moving eligible goods for that importer, and all drivers, must be approved. However, if the importer only wishes to take advantage of the CSA streamlined accounting and payment system, there is no need for the carrier and driver to be approved.

The system shows the CSA Revenue Summary (RSF), E648. If the importer finds that they are owed money, they may apply for a refund. Examples of debits that may be listed on the RSF are duties, GST, interest, and penalties. Credits might include a refund of duty, drawback, or interest. Payment of the RSF is made through a financial institution, and multiple payments may be made during the month to avoid incurring interest.

The system is safeguarded by the understanding of the Customs Trade Verification Manuals of Member-nations, which instructs the verifications officers seek to preform, during the event of a customs audit. The audit processes is divided into three phases, beginning with pre-planning, execution and reporting, which verifies the steps of compliance that an importer/exporter must follow prior, to any customs assessment.

The system describes a customs audit as performed to ensure that information provided to customs agencies are accurate, reliable and conforms to the expected standards. An audit provides assurance that compliance with rules and regulations exists, and is a means or mechanism for detecting non-compliance. The enabling body of a customs audit is a Customs Agency issues a Detailed Adjustment Statement (DAS) it is in fact an audit since it's a review of a declaration or an entry, an evident notice of disagreement. Customs reviewed a declaration or entry and found an error or, omission, knowledge of previous rulings, or identified a blatant error in classification, including errors made as a result of incorrect data entry.

If there is a requirement to pay additional duties and taxes, they must be remitted within 30 days. The importer can appeal the decision; however, the payment must still be remitted within 30 days.

The system safeguards importers and exporters from customs audit through program verification audits which are the means of measuring voluntary compliance and developing risk assessments, and random verification audit data is used to measure overall trade compliance, identify weaknesses in a trade program.

The system provides transparency between importers/exporters, by providing logistics service on a global, domestic and local scale, in any region of the world. The benefit received by importers/exporters is that the system is able to analyze the anti-dumping, countervailing or provisional duty that can be applied in select member-nations for good(s) that are harming another member-nation's industry.

The system recommends undertakings to the exporters or the foreign governments to change their pricing or subsidizing practices in to order to eliminate harm to the member-nation's industry. The system evaluates the injury occurred when the member-nation market has been affected adversely by the imported goods. Injury may be shown by: reduced prices; lost sales; lost market share; decreased profits; and other difficulties. The system examines the margin of dumping which is the amount by which the normal value exceeds the exporter's export price for the goods. The anti-dumping duty assessed is equal to the margin of dumping.

The system has an active record for the measures in force, for every member-nation, that flags importers/exporters for SIMA, the criteria is as noted below, once published; this information is integrated onto the system:
Product information
Duty Liability (Anti-dumping duties if applicable)
Duty Liability (Countervailing duties if applicable)
Disclosure of Normal Values and Amounts of Subsidy
Investigative Information
Harmonized System (HS) codes
Information Required on Customs Documents
Duty assessment—Contacts
Reference numbers: Customs Agency
Reference numbers: International Trade Tribunal

The system's SIMA process is as follows:
1. Starts with a compliant, or a red-flagging in the system;
   a. Whereas, the local transaction cost(s) are compared to international rate(s)
2. The system advises the importer/exporter for administrational errors/omissions;
3. The system determines whether there is evidence of dumping or subsidizing; and it has determined that dumping has occurred, the responsibility is to determine whether dumped or subsidized imports have caused material injury or are threatening to cause material injury to member-nation producers of like goods.

The system processes the release for goods shipped and carried by a courier or sent by mail. In the courier mail process a cargo/release list replaces individual cargo control documents. This list is often called a consist sheet. The consist sheet summarizes for the customs agency what is included in a particular shipment. The consist sheet must be presented to the customs agency by the courier prior to, or immediately upon, the courier's arrival in the member-nation. Following is a step-by step process of a typical chain of events for a courier shipment from the exporting country to the country of import. On the system, the exporter prepares goods for shipping to country of import. This includes the preparation of documentation and packing of the goods. The package is picked up by, or delivered to, the courier, who assigns a bar-coded tracking number. This number is entered into the courier's tracking system, and each time the package changes hands, the bar code is scanned so that the exporter is aware at all times of the location of the goods. All packages are delivered to the courier's central hub in the destination where they are sorted according to their delivery location. Since the paperwork is inputted into the system, the member-nation's (country of import) customs broker is indicated, the packages are sent to a the (country of import) hub that is closest to its final destination. When they arrive at the hub, those that qualify for release under the Courier/LVS system are released by the country's customs agency and the packages are sent for delivery. The release documents are electronically delivered by the courier to the customs broker so that final accounting can take place.

The system classifies the goods temporarily imported that are classified as “temporary imports,” as long as they are not being imported for sale, lease, further manufacturing or processing, may be entered free of duty under tariff item 9993.00.00. However, certain exceptions do apply to the tariff assignment, where, some goods are permissible, while others are exempt (i.e. the tariff applies to good(s) such as repair, overhaul, alteration, adjustment, storage, display at an exhibition of similar manufacturers, racing, testing, certification by an accredited organization, or to be employed in the production of films or commercials, or in response to an emergency or emergency response training exercise.)

The system obtains approval goods on-site clearance—either at the show or at a customs bonded warehouse—the goods can be shipped directly to the event site. Customs agencies will have an officer on-site to review documentation and perform any necessary examinations.

The system processes various types of self-adjustments for importers, according to the Customs Act and the section it pertains too, i.e. Customs Act Section 74, the self-adjustments also pertain to overpaid taxes

The system provides legal protection for importer and exporters who require appealing their matters in the trade tribunal, regarding a customs compliance matter. The system has a network of trade advisors and attorneys who are professionally knowledgeable of the Customs Act and the Customs Tariff to appear before the Tribunal and conduct a good background in general court procedure, regarding the points of law and referrals to previous cases involving similar instances are not uncommon. Some parties may choose to be represented by legal counsel.

The system inquires into complaints by potential suppliers concerning procurement by the federal government and assists with deciding whether the federal government breached its obligations under certain trade agreements to which member-nation(s) is party.

The system prepares importers/exporters on decisions of the customs agencies made under the Customs Act and the Special Import Measures Act (SIMA) and of the Revenue Agency made under the Excise Tax Act. The system inquires into and provide advice on such economic, trade and tariff issues as are referred to by the Tribunal. The system inquires into complaints by domestic producers that increased imports are causing, or threatening to cause, injury to domestic producers and, as directed, make recommendations to the other government(s) on an appropriate remedy.

The system adheres to the Exporters' and Producers' Records Regulations which stipulates that records must be kept for a period of six years after the date of exportation. These records include all information that relates to the: origin, purchase, importation, cost and value of the goods; payment for the goods; use to which the goods are put in the country of import; exportation of the goods; and source of all materials used in the production of the exported goods.

The system provides the means of Reporting of Exported Goods Regulations, there are three different groups of people responsible for exporting: exporters, carriers, and Customs Service Providers (CSPs). The exporter is responsible for reporting the export accurately and within the required time frames.

The system adopts the export reporting regulations of all the member-nations, and classifies the requirements according to the country, type of good(s) and requirement for reporting.

Carriers via air, marine, rail and highway carriers may submit export declarations to customs agencies on behalf of an exporter. The exporter is responsible for ensuring that accurate export declarations and documentation is presented to customs agencies within the prescribed time frames. The system creates export declarations on behalf of the exporter, the customs service providers (CSPs) prepare export documentation on behalf of exporters, make transportation arrangements for the exportation of the goods, and report the export, to provide the exporting carrier with proof that the goods are reported to customs agencies.

The system supports the export declarations on a member-nation basis, for example, in Canada there are four types of export declarations: CAED (Canadian Automated Export Declaration), G7 Electronic Data Interchange (EDI) Export Reporting, B13A, and the Export Summary Reporting program.

The system supports the Export Summary Reporting program developed to enable exporters who meet certain criteria to declare export data in a single summary report. This report streamlines export data and provides international trade statistics. Exporters in this program may submit a monthly summary of their goods after they have been exported.

Summary reporting is for exporters of low-risk goods and, without special permission, cannot be used for goods subject to export controls. Companies wanting to enrol in the program must contact the customs agency in the region where the company keeps its records or nearest to the place where most of the exporter's goods will be exported. The application should include a copy of the proposed Summary Reporting. Summary reporters must submit a report covering the previous month to Statistics of the Respective Country within five business days after the end of the month in which goods are exported. A nil report must be submitted when there are no exports and nothing to report for a particular month. The system automates export reporting through electronic exchange with Export Reporting Offices, which is usually any customs agency office that is designated under Section 5 of the Customs Act to process the exportation of goods from the member-nation, to receive export reports, and to examine goods destined for export, as well as being open for business at the time the goods are reported. Goods destined for export may be examined, they must be available at the export reporting office where the export documents are presented. Exporters who report their exports electronically send their export declaration directly from their place of business to the customs agency. This type of export report is considered to have been submitted to a customs agency place of report and the place of exit. B13As are submitted to the export reporting office where the exports are reported. Summary reports must be submitted directly to Statistics.

The system support export declarations with shipping documents such as, Bill of Lading—a contract between the carrier and the shipper to transport the goods. It is issued by the carrier to the shipper. It serves as evidence of the conditions of carriage agreed upon between the shipper and the carrier, and a document of title to the goods.

The system provides a procedure of filing goods returned, for reverse logistics, as it may be interpreted as meaning “all goods grown, produced or fabricated in the country of export, exported from the country and subsequently returned”. Goods returned are defined as re-importation of goods exported from a country and returned without having been enhanced in value or improved in condition or subjected to any other type of modification while abroad.

The system provides assistance in classifying the returning good(s) according the HS-number.

The system is based on certain conditions, where if met, the duty drawback program is accessible, but, if not, the system does not proceed further.

The system also calculates the tax status of special case(s), for example: when an exporter company sells goods to an importer and the goods are delivered to the importer, the goods are not subject to GST. However, if the goods return to the exporter's country, they are subject to GST at time of importation. If the goods are exported by the exporter (owner) for lease outside of its country and re-imported by the same owner at the end of the lease, the goods are not subject to GST. However, if the goods are imported into Canada by someone other than their owner, GST applies. If exported goods are zero-rated and are later returned to the exporting country, GST applies.

The system processes the return good, if Proof of Export; whereas the exporter must have proof of export from the country, including transportation company documents, such as a bill of lading or freight invoice; customs accounting documents of a foreign country; or a declaration by the importer/exporter supported by commercial documentation identifying the goods as having originated in the country or as having been previously imported.

The system classifies goods abroad as the practice of exporting goods from a country in order that they be repaired or modified, or have parts added to them, or tested while outside of the country of export. It is possible that there is no local expertise that can perform the necessary repairs or modifications.

The system presents different possibilities for the goods abroad program based on the tariff treatments, type of modification (additions), type of commodity and nature of the work-order, for the process of relief on duty/taxes. The system assists exporters, and re-importers with qualifying for relief on payment of duties and taxes, as long as the conditions were met, and the set time-limit for return was processed on-time.

The system advises the re-importers that upon return, the commercial invoice must indicate the full value of the goods, that is, the value of the goods at the time they were exported from the country of export plus the value added to the goods while outside the country of export. The invoice should show the value of the repair, addition, or work done abroad and include any associated production costs such as materials, direct labour, direct overhead, and profit charged by the foreign repair facility.

The system advises what portion of duty/taxation relief the exporter/re-importer can obtain i.e. if the repairs were under-warranty (not subject to tax) or non-warranty (taxable on repair costs).

The system allows importers, producers and exporters to delay or defer the payment of duties on imported goods. This can be done by storing goods in a warehouse before entering the domestic market for consumption, it could involve goods being exported in same condition as they were imported or consumed in the processing of other goods, or goods that are further manufactured in bond for foreign markets. The Duty Deferral Program includes three programs: Duties Relief; Customs Bonded Warehouse; and Drawback. This program alleviates the obligation to pay duties on imported goods that will eventually be exported either in the same condition or after being used, consumed, or expended in the processing of other goods.

In this system, the relief of taxes can be processed under another processing service program i.e. Canada's Exporter of Processing Services (EOPS) program. The EOPS program relieves GST at the time of importation if the goods will be processed and exported. The goods must be exported within four years. To qualify for this program, the importer must be a GST/HST registered company.

The system holds a database and processes the application for customs bonded warehouses are licensed by customs agencies and operated by the private sector. Goods in a bonded warehouse are considered to be imported into a country but not released. Imported and domestic goods destined for export may be placed in a bonded warehouse before they are exported.

The system provides guidance and processes application requests for the drawback program, which is an incentive for domestic manufacturers who produce goods for export.

The system processes the application on form i.e. Canada's K32A, completed to support a drawback claim when the party claiming the drawback is not the importer. Form K32B must be completed to support a drawback claim when the party claiming the drawback is not the exporter.

The system is designed around the framework of the U.S. Customs the Automated Commercial System (ACS) for tracking, controlling, and processing all goods imported into the United States. The system accesses the U.S.'s Pre-Arrival Processing System (PAPS) is a release mechanism that utilizes barcode technology to expedite the release of commercial shipments entering via Canada by highway carriers. With PAPS, the carrier provides the U.S. customs broker with required release information prior to departing Canada of export for the U.S. The system processes alerts for accounting 15 calendar days of the date that goods arrive at a U.S. port, entry documents must be filed at a location specified by the port director.

The system processes an Entry Summary Form CF 7501 filed and estimated duties deposited at the port within 10 working days of the goods arriving. The entry package is then returned to the importer, or customs broker.

The system enables the information provided in Forms CF 3461 and the CF 7501 may be submitted electronically using EDI. Under the terms and conditions of the agreement between the client and the broker, there is a shared responsibility for compliance and accountability. However, it is the ultimate responsibility of the client to pay any customs duties. The system advises importers on importing food into the U.S., registering a company with the FDA, through the system, companies located outside the U.S. appoint the system's approved U.S. agent for FDA communications.

The system connects sellers (exporters) and buyers (importers) through a sourcing network to facilitate international trade via an internet gateway. The system offers its users connectivity with approved importers and exporters for specified member-nations in the same trading market as the importer or exporter, find written scenarios below. The system offers interconnectivity between importers and exporters that have an active profile on the exchange market via this portal.

The system offers an advantage of interconnectivity, whereas, certain buyers and sellers are unknown to each party, with this display of interconnectivity the supply chain of a buyer or seller is formidably improved, compared to the existing supply chain network in the importer or exporter's current network.

The system connects these two users through the exchange market established through the logistics service provider, in which:
(a) Credibility is proven through financial credit score(s)
   i. Ratings via financial institution or, credit-agencies of member-nations
(b) Validation of product(s) traded on the electronic exchange market, whereas validation is described as an approved product in a member-nation.
   i. The validation cycle is approved, dated and originated from a specific member-nation and monitored by a logistics service provider through the system.
(c) Approval stages are processed through the system's sourcing mechanisms whereas, the credibility of an importer or exporter are established by the logistics service providers operating through the system.
   i. In the exchange of goods, approval is obtained by the member-nation's customs agencies and other government departments, to ensure safe and secure trade is processed in the member-nation where a buyer or seller desires to operate.

The system validates a contract of sale vis-à-vis: offer, consideration and acceptance, in which, the buyer or the seller can request to market their goods on the exchange service, via the online portal. On this online portal, importers can transact with exporters, and exporters can transact with importers. All in which, existing importers can source better exporters to serve their supply chain, vice versa.
(a) The seller (exporter) is in the business of selling products that are approved by the country of import, and documentations verifying the validity of import are generated and approved by the member-nation's customs agency and other government departments.
   i. The seller's intent is to explore new markets in the member-nations serviced by the logistics service provider
   ii. The seller's intent is to obtain registration of products with other government departments and customs agencies in the member-nations for the purpose of marketing/exchanging goods.
   iii. The seller's intent is to source product(s) that are approved and up-to the nationalized standards of member-nations.
(b) The buyer (importer) is in the business of purchasing products for a particular end-use of a finished product, or, a registered wholesaler or distributor of a particular good. The buyer's intent is to purchase good(s) that are approved and accredited by the country of import, and approval ratings are generated by the member-nation's customs agency and other government departments.
   i. The buyer's intent is to source competitive products final manufactured product

The primary reason(s) for the system to generate an exchange market is to connect buyers and sellers, both of which are in the pursuit of upscaling their business in competitive markets where these buyers or sellers are exchanging goods.

The primary difference(s) between this sourcing network compared to competitors is that:
1. The system is primarily a logistic service provider, where, importers and exporters can connect, and arrange their logistical service through an online trade gateway.
   a. Whereas, importers and exporters, can compare logistics service provider(s) on a global, domestic and local level, arranging the logistical service aspect of their shipment(s) through multimodal transportation, and with a multitude of logistics service providers, for the various stages of their logistics process.
      i. Typically, door-to-door shipments have a minimum of (7) intermediaries involved in the complete shipping process.
         1. The system facilitates numerous logistics service providers, at every stage of transport, whereas the importer or exporter can compare quotations according to their set budget, and trading terms and conditions negotiated between the buyer and the seller.
   b. Whereas, importers and exporters are only connecting with credible buyers and sellers. Credibility is established through, the financial history, credit-agency score(s), trader's database, exchange history via the system, trade reference(s), creditor's rating(s) and/or current trade or financial projections.
      i. Another foundational body of a trader's worthiness comes from their approved product(s) in member-nations, which are documented and verified by customs agencies and other government departments.
         1. Obtaining registration and approval of certain commodities that a manufacturer produces in a given country, is not the same in a respective member-nation. The reason(s) for this difference exists because, there are different standards of safety, and measures imposed on the product rating(s) of the goods.
         2. Obtaining registration of good(s) produced by exporters of different member-nations requires a trade advisor, customs broker, representative of other government departments, and independent organizations who have the knowledge, skill and resource(s) to accomplish the said matter.

The system acknowledges that manufacturers require certain good(s) to be sourced, supplied and shipped to their facility in a select member-nation.
1. The user can post a request to locate a specific product
2. The request will be shared with the respective users (i.e. importers and exporters) who have the status of buying and selling agents to assist with the request.
3. The request will also be processed on the exchange market, where it is be visible to respective users of a trading community, this database will compose of:
   a. Trade Associations of Member-nations
   b. Buying and Selling Agents
   c. Importers and Exporters

The system also processes requests by finding the appropriate importers and exporters, on the exchange system, that has been approved by the system processes of on-boarding.

In general, the system has a database of importers and exporters databases provided by the respective member-nations, i.e. Canadian Importers Database of Exporters Canada. Moreover, the World Customs Organization holds data for the respective exporters and importers involved in the global affairs of member-nations.

Hence, the system acts as a data-reader and receiver, holding valuable information of importers and exporters in member-nations, around the world, and therefore, facilitating trade in a highly fluctuating market can be monitored and traced by the mechanisms of the system.

The purpose of this system is to help importers and exporters expand into new global by reducing barriers to trade between member-nations, by systemically technologizing the custom agency's rules and regulations and other government department requirements of member-nations in the World Trade Organization. The system has an exchange market, where buyers and sellers of member-nations can connect with one another and expand their trade. The system offers this service to buyers and sellers currently active on the logistics platform, and encourages new buyers and sellers to take part in the active exchange market.

Overall, the system creates a one-to-one internet trade gateway connecting buyers and sellers in the industrial sector through a global marketplace, where buyers and sellers are applicable to exchange. Other advantages are as follows: Display their product(s) according to the member-nations that they are eligible to export too, in which, they have the required customs agency approval, and other government department licenses and regulations for the respective trading nation(s). The users can post requests and receive inquiries from acceptable buyers or sellers, even if those respective bodies are not currently approved to import or export to the member-nation of request. The importer or exporter can receive trade advisory services from logistics service providers apart of the larger network facilitated on the system, where they can obtain approval into the respective trading nation(s) where they have a request for supply. The required logistics provider will obtain approval of the good(s) that the respective importer or exporter, wants to transact into their member-nations. The users can obtain authorization and approval for goods in member-nations that the system operates in, and the goods are applicably up-to the standards of the member-nations (i.e. country of import). The system acts as a trade intermediary between importer(s) and exporter(s) that are approved by the processing features of enrolling a new user on the system.

The shipping documents (i.e. customs invoices, bills of lading, packing slips, certificate of origins) are transmitted into the internal database of the system for compliance related specifications.
1. The system accesses this information to respond to requests for sourcing goods, that is inputted into an end-product made by a manufacturer.
2. The system contains a set of numerical trade information that is transmitted to the customs agencies, where the pertaining trade information for a custom is inputted numerically into the system, and it is stored, thereafter, as a piece of trade information.
   a. The system can simulate this trade information amongst similar importers and exporters, matching the trade data, and comparing this trade data for purposes of customs audits.
      i. Whereas, the system can find out discrepancies in trade data and good(s) that are being exchanged on a global, domestic and local market. The primary focal of a customs audit, is described in the proceeding documents.

A customs audit can be avoided with correct pre-screening measures that are initiated by an importer and exporter and between customs agencies and other government departments. The system acknowledges that the information an importer or exporter declares must be transparent between one another, for instance, the exporter must declare the correct:
Value of exchange (commercial invoice)
Origin of goods (certificate of origin)
Contents of the shipment (packing slip)
Shipper's validation (bill of lading)
Description of the Goods (harmonization code)
Tariff Treatment and Code (tariff treatment applied)
Valuation of the goods for the tariff treatment (certificate of origin)
Estimation of duty and tariffs (B3 entry)
Terms and conditions of the trade (INCOTERMS—cost, insurance and freight)
Usage of the goods (prior to export)

To avoid a customs audit, or a general issue, an importer and exporter must submit proper declarations that are transparent in the cycle of the trade, and therefore, there should not be any discrepancies with the declarations that are submitted by either party. The system mandates a close-connection between customs agencies and respective importers and exporters, submitting and transmitting trade data, before an importer or exporter's account is opened in the system. The system maintains a standard procedural protocol, by acting as a quasi world customs agency, facilitating trade between the importer and exporter, providing complete end-to-end visibility, where there are not any discrepancies between the declarations of the exporter or, importer. (how?—process is explained in the proceeding customs documents). The system maintains a control mechanism, where, an overage or a shortage is detected, prior to export or, import, processing self-automated audits detecting errors and response action plans for the respective importer or exporter.

The system takes a comparative approach by exclusively comparing different importers and exporters, according to their HS-code (harmonization classification), and citing various commercial value for good(s), duty and taxation, and conditional charges by respective customs agencies in member-nations.
a. The system takes (all) of the trade information submitted into the software program, and simulates the information according to the respective:
   i. Importer and Exporter (buyer and seller)
   ii. Origination of Goods, Commercial Value of the Goods, Harmonization Number of the Goods, Description and Imaging, Value of Sale relative to the Quantity, Value for Duty and Taxation
      a. The primary goal(s) of this information is to make a relative trading forum, where the importer and exporter's data information can be compared according to the set of data that is transmitted onto the system.
      b. It can notably take error reports, by examining the assignment of HS-numbers, according to the country of origin, and the general commodity description(s) of the goods.
         i. Therefore, in the event that a request is processed through the sourcing channel, the product can be found on the respective exchange market, and the request for sourcing can be processed accordingly.

Advisably, if the importer or exporter is setting up a good(s) for import or export, the most appropriate form of release methodology follows the general customs procedure, which results in the storage of trade documentation(s) and the accumulative data-entry related to the member-nations in which the good(s) are being traded, (stored) into the respective customs software.

The benefit of having this information stored, into the internal system is for the primary sake of conducting self-assessments of importer/exporter customs accounts for customs compliance, ensuring that users are compliant up-to the respective member-nations customs standards. Often, these standards are set-in-place by the World Customs Organization, and its respective regulatory bodies as well as, other international associations. The enrollment and publishing of their updated documents are published and used as trade news for each product, that is imported, into any given respective nation. The monitoring of this information over a certain period of time, is ensured through the respective customs brokers, trade advisors, independent trade professionals that will be apart of the larger network and database on the system.

Some of the responsibilities granted to a select designee, will be to update and provide reasonable responsiveness on the respective product(s) and good(s) that they have an interest in on the system.

The system offers an advantage of:
1. Comparison between exporters and importers of a select member-nation.
   a. Advantage: The system can concurrently audit various exporters and importers, allowing the system to detect errors in the entry-process of select exporters and importers.
      i. This pertains to dumped, or subsidized good(s) of a particular nation
   b. Advantage: The system can assess the amount of trade facilitated between an importer and exporter, and the rate at which, an importer or exporter can provide their good(s) to another inquiry.
      i. This pertains to the exchange market developed through the database in the system.
   c. Advantage: The system can conduct its own audit(s) on behalf of importers and exporters, comparing and contrasting their good(s) with other importers to evaluate the correctness in the information they've submitted to the customs agency in the member-nation.
      i. This pertains to facilitating compliant trade by importers and exporters, and the member-nations they've imported or, exported too.
   d. Advantage: The system can evaluate the trade data, and have a collection of the trade information, and how the pertaining information changes from one country to another.
      i. This pertains to global trade management solutions.

In the importer and exporters profile, the select product(s) of import or export will be stored, filed and maintained in their select portfolio, and organized according to the member-nation that the importer or exporter is trading in, i.e. every member-nation will require a different set of documents to be maintained, and stored into the system. Accordingly, when a different importer or exporter requests a select import or export to be processed in a selected member-nation, the system scans the relative trade information, and processes an automatic request for pertaining trade information and data.

The system stores trade information for it to be easily accessible by importers and exporters, in the event of a customs compliance audit by a select member-nation. The system uses the information of a select importer or exporter, to assist with the preparation of customs documentation for another importer or exporter, that may have service request. The advantage sought from this is a streamlined process of data management, and better facilitation of trade, in select member-nations, without errors.

The procedure(s) of facilitating Trade is as follows:
1. The system contains member-nation's requirements for the select good(s) in the customs tariff of select member nations, this information is accessible and published under the public domain of member-nations, titled as “importing (select good) into a (select nation),” can be searched on the worldwide web, and a process map, of “how-to” import can be created with research and developmental support.
   a. In the World Trade Organization, composing of merely 120 countries, there are similar processes of facilitating trade of each type of good/select good(s) that are processed in the pertaining country of import or export.
      i. The obligation of the exporter and importer are similar as well, normally, in order for an importer to import select good(s) into a member-nation, compliance measures and communication must be maintained with the exporter for approval of good(s) into a member-nation.
         1. As advised, the advantage that a select importer or exporter receives is the benefit of facilitating trade in multiple member-nations, aside from the primitive nation, where the good(s) are wholly obtained or made.
2. In the process of facilitating international trade, where the system acts as a gateway to help businesses explore new markets by reducing barriers to trade, select trade advisors, for select shipment(s) will be recruited into the network of trade professionals, whom will provided inquiries and service requests.
   a. This service request will be processed via an electronic exchange market, for trade advisors, whom will be responsible of facilitating trade for importers and exporters, desiring to explore new markets in the globalizing world.

The system is developed to handle what happens in any export/import transaction. There are three areas where the skill and expertise of the freight forwarder can make all the difference:

The system prepares documentations for shipping electronically, through the online portal, and mainframe, where logistics service providers, importer, exporters and producers can access the system for editing their shipping documents.

Firstly, the system invites trading associations of a number of member-nations, to join the trader's portal for selective events and organized activities that the system facilitates. Secondly, the system encourages trade professionals of different organizations composing of buyers and sellers, to connect with one another, to facilitate greater trade endeavours into their marketplace. Thirdly, the system employs buying and selling agents of select good(s) where there is a market to be explored, in order design, select, and act as a trading intermediary on behalf of the select importer or exporter. Fourthly, the system connects buying and selling agents from organizations of all sizes, under a larger umbrella for initiating trade, where organizations can facilitate their trade with larger corporations, through the system's larger trade alliance maintained as a board of members to the organization(s) global trade network.

The system evokes the propagation of connecting businesses and people, opening up the corridors of trade as a one-on-one trade relationship between importers and exporters, as well as, businesses and organizations.

In addition, there is another possibility where the system facilitates alliances between the likes of intermediaries on the electronic exchange, allowing for a type of merger and acquisition for project-bidding for logistics inquiries facilitating a supply chain for a long-period of time, over the span of an annum.

The system is developing a levy of space to expand its territory into various sectors, assisting start-up companies in different industries, begin and maintain trade through a supply chain network.

The system sets up a locality of logistics service providers, at a courier-based system of picking/packing and shipping select products to the next-destination, in the supply chain.

The system operates to set-up local supply chains according to the primary sourced textile/fabric in the piece of garment that is designed/purchased. The system offers an advantage of using an existing database of importers and exporters to source the fabrications around the world, according to the customs tariff of the region. It accesses the electronic exchange market to find the correct importers and exporters of such fabrics to source the channels of executing the product, to-be developed.

The process of the application flows a model of interacting with, small, medium, and large companies for all of the different types of services required for processing the textiles and fabrication industrial scale. The products involved may be sourced from various geographical settings i.e. global, domestic and local, where a contract logistics platform is helpful for execution.

The system acts as a trade network in the fabric and textiles industry, connecting designers to their supply chain, and assisting them with marketing their goods to consumers, by facilitating a local trading network in global, domestic and local industries, where, such supply chains of large-scale multinational textile and fabrication industries exist, i.e. Bangladesh, Vietnam or, Philippines. The system networks with localities, where these raw materials (i.e. fabrics and garment-related goods) are at an abundance in the marketplace, however, they are often inaccessible by local businesses, to create a large-scale economy on a global, domestic and local level. The system networks with local medium, and small retailers who hold these garments at an abundance, however, and a local market-based economy does not emerge amongst them, through this system locals are connected to global consumers.

The system creates a local economy in developing countries, where textiles and fabrics originate organically. A local fabric, textile company that has a bulk-holding of textiles and fabrics can open-up accounts on the system to build a databank of suppliers, up-to standards of the member-nation of import. From there, a local, unemployed child, will be hired to pick-up the fabric, deliver it to the seamstress, wait for the stitching order to be completed, then deliver it to the courier, all the while, these updates are provided through the system, to the consumer, on an as-needed basis. Once the order is completed, the shipping company of the designated area, assigned by the system will pick, pack and ship the goods to the destination.

The goods are declared based on the value of the shipment, as insured by the exporter, legally, this value reflects the total shipment value declared by the exporter, and not the transaction value of the overall shipment(s). The declared value(s) of the goods are a reflection of EXW (INCOTERMS) since the goods are being facilitated for trade, based on the total transaction value, and the end-consumer without any obligation to any such externalities or other charges fees incurred by the end-consumer. The customs action plan is created for every member-nation where the goods are being imported, whereas the most compliant trade activity between a business and consumer is determined prior to import or export, and future compliance measures are handled prior to a customs audit being conducted by a customs agency of a member-nation. (Considerations can be placed on the usage of chapters 98/99, for certain good(s) that are transacted, according to the rules of origin and use of goods.) The majority of the trade rules and regulations set in place for this model of exchange will be the courier low-value shipment (CLVS) program of set member-nations. The compliance measures of each good being imported/exported will be declared and consulted of, before processing an import/export. The taxation paid to the member-nation of import, will be based on the declared value of the shipment(s) and the revenue agency of the country of export, determines the amount of taxation to be paid for the total transaction value.

The system utilizes a trade network to objectively execute a logistics process between the intermediaries of international trade, to accomplish the transportation operations supply chain process. The system acts as a trade intermediary between buyers and sellers, and helps buyers and sellers facilitate trade by acting as a party to a sales transaction.

The system is a supply chain network built to connect importers and exporters through one platform, where sourcing, exchanging and transacting good(s) on an electronic exchange market is made possible. The system facilitates importer-to-exporter transactions by connecting its users with financial institutions (i.e. banks, creditors and credit agencies) and contracting points of sale with the use of international trading terms and conditions, in which the importer and exporter have certain roles and responsibilities to fulfill, prior to receiving payment(s) set-by the financial institutions of the parties to agreement, ensuring that the good(s) are securely exchanged through the system.

The system processes logistics after terms of sale are finalized through a global logistics service network of licensed customs broker(s), trade advisor(s), freight forwarder(s) warehousing and distribution facilities and cargo carrier(s) from origin to destination without any errors or, delays ensuring compliance is enforced at every step of the supply chain network on a global, domestic and local scale.

The system reduces trade barriers by assisting importers and exporters with customs compliance on the global, domestic and local scales of the world. Whereas, the importers and exporters on the system, can access trade advisory services to enter any global markets in the world.

The supply chain network is built to reduce trade barriers between nations and create a transparent trade environment in global zones. The system evaluates users prior to their access on the program. The active user(s) are provided later.

The system connects importers and exporters on an electronic exchange market, where users can source inputs, process their input(s) into an end-product with processing plants or, manufacturers and arrange the logistics service for their supply chain, through a single provider. The system connects importers and exporters who facilitate safe and secure trade in global, domestic and local scales of geography.

The system increases interconnectivity between importers and exporters by helping both parties enter new markets, where an importer or exporter is not currently exchanging goods. For example, a select exporter may not currently be exporting to the country of import, where a potential importer (buyer) is located, and therefore: The system's trade advisors provide exporters (i.e. manufacturers, producers, wholesalers or distributors) consultations of “how-to” enter new markets (i.e. member-nations) by obtaining approval for their good(s) with select governments and other departments. The system's trade advisors recommend to exporters “how-to” facilitate trade in foreign markets, without errors and discrepancies with customs agencies or, other government departments in member-nations. The system enhances trade between exporters and importers on the platform by reducing barriers to trade in global markets.

The system compares trade information (i.e. customs documentation) in select member-nations pertaining to a specific harmonization-code (i.e. commodity) being imported or, exported from a select member-nation, to help another importer or exporter process trade relations in another country. The system automates a connection between Importer (a) with Exporter (b) for sourcing an input to an end-product, ultimately reducing its cost(s) of production. However, Exporter (b) may not have the mandatory approval from the country of import for Importer (a). The system recognizes this as trade barrier and proceeds by recommending trade advisory, and to obtain approval for the good(s) from customs agencies and other government department, in the country of import. The system is programmed to process approvals through a “step-by-step” procedure of obtaining approval(s) for select good(s) to be imported in a different member-nation.

The system compares the electronic documentation(s) of importer(s) and exporter(s) ensuring that complete compliance measures are enforced, for select harmonization-code(s) of specific commodities classified according to the Customs Tariff.

The system processes a transaction between the importer and exporter, by negotiating terms and conditions for sale. The system connects financial institutions (i.e. creditors, banks, and others) to importers and exporters to issue letters of credit on behalf of the importer and exporter. The international trading terms base the contractual relationship between the importer and exporter for a transaction.

The system processes a transaction between importer(s) and exporter(s) through the electronic exchange market, on which souring input(s) and product(s) for manufacturing end-product(s) is enabled. The system processes input(s) with data related to the use(s), and further processing of input(s) including: The entailed use of the input(s), whether, it is further processed in a facility; the intended end-use of the input(s), i.e. in which end-products the input(s) are used; and, the potential market of the input(s).

The system creates an algorithm according to the product composition(s) or, input(s) of production in the select end-product(s), and further researches the development phase(s) in completing the final end-product. The supply chain process is understood by accounting for all the various intermediaries involved in the completion of a product:

The system ensures the supply chain of an end-product is accounted for by examining the input(s) making-up the end-product, whereas, the input(s) must undergo specific analysis and test(s):
a. Product-Quality Analysis Test(s);
b. Laboratory Test(s);
c. Commercial Sampling; and other

The system ensures that analyses and tests are mandatory, considering that input(s) are processed as phases of development for the end-product, and therefore, (all) inputs require documentations and testing to be incorporated into an end-product.

The system expands sourcing of good(s) into sourcing service(s) as well, where importers and exporters can obtain quality assurance tests, analysis (then) processing, further manufacturing (or) assembly, packing.

The system understands the supply chain process of select good(s) by obtaining information on the input(s) (i.e. what is the use of the product, and what end-products is it inputted into?) this information is attainable importers and exporters, involved in the supply of product(s). In addition, (all) inputs are classified according to a harmonization-number, which has a customs procedure mandated, for approval of importing select input(s) into a country.

The system's overall process is to implement a manufacturing network, of design and operations creating value-added chains distributed over several manufacturing sites, in which, contract-manufacturing becomes a reality through a supply chain network, that adapts highly competitive manufacturing networks.

The system develops its manufacturing network (or) manufacturing procurement network (i.e. contract manufacturing) by, analysing the supply chain of select products, classified according to the NAICS codes, and the selective HS-numbers pertaining to the classified industry. Agreeably, end-product(s) contain numerous input(s) (i.e. raw materials) that are processed, refined, sub-assembled, and combined with other input(s) to make an end-product. The manufacturing procurement network proves to be beneficial in a world of dynamic, unprecedented change, and it can be retrieved by: Examining the patents and trade-mark technology of good(s), and Research and development for providing consultations of manufacturing and production of good(s).

The system implements a manufacturing network of value-added chains by integrating the knowledge of engineers who use six sigma and lean manufacturing concepts for design and operations of product development, through these steps, a simulative plan is developed, where the supply chain process is developed from start to finish.

The system implements the design and operation of products, to engineer a final end-product through a sourcing network of inputs, and a network of service providers to process, manufacture, assemble and construct the end-product.

The system allows information of manufacturing, processing and product-development to be accessible to develop, focused on quality management, planning of production and logistics, purchasing and controlling the product procurement process in developing an end-product.

The system interconnects the processes of making good(s) and the role of service provider(s), interworking a flow of “how” good(s) are processed in conjunction with service provider(s) and, “how” globalization impacts the process of making good(s) and the role of service provider(s) with product-development, and the processes by which, people-to-people relationships are influenced with changing competitive trends in the global marketplace.

The system provides engineering and manufacturing development service(s) for product(s), whereas design and operations are constructed by consultants who are experienced in select industries, and specific product development capabilities. The system sources the input(s) in the procurement of making an end-product through a supply chain network for strategic product development. The system processes an innovative production system, in which, the innovative technology and new forms of work organization are analysed for industrial development prior to large-scale manufacturing. The system plans a manufacturing and assembly process is tested for product sample creation and stability in the operation(s) and performance of flexible manufacturing.

The system processes transactions between importer(s) and exporter(s), and once trading term(s) and condition(s) are negotiated, the responsibilities of the importer(s) and exporter(s) are reflected in the logistics service process, considering the terms of payment including cost(s), insurance(s) and freight charge(s).

The system processes requests for quotation(s) with shipment details and the user's needs according to the trade terms and conditions negotiated between the importer and exporter. The system processes requests based on the trading terms and conditions, origin and destination, cargo description and dimensions as well as cargo handling instructions. The system processes the international trading terms, according to the scale of responsibility an importer or exporter has in the agreement for the transaction, and therefore, the quotation is presented in segment(s) where, the level of responsibility is transferred as a quotation to either party, nonetheless, complete transparency for the total logistics service charge(s) are shown in the final report.

The system calculates the request for quotation based on the shipment details, and decides on the route(s) and carrier(s):
1. The system processes air and ocean quotations for shipment(s) destined across member-countries.
2. The system processes quotation(s) into phases, where, quotations for door-to-door service, are divided up into stages of quotes, for example:
   a. The trading terms; select the INCOTERMS
   b. The packing of good(s); packing provider (a), (b), (c)
c. The cargo insurance; insurance provider (a), (b), (c)
d. The shipping document; freight forwarder (a), (b), (c)
e. The export declaration; customs service provider (a), (b), (c)
f. The origin to the port; logistics service provider (a), (b), (c)
g. The processing location; warehouse (a), (b), (c)
h. The import declaration; customs service provider (a), (b), (c)
i. The port to the port; logistics service provider (a), (b), (c)
j. The processing location; warehouse (a), (b), (c)
k. Off-port to the destination; logistics service provider (a), (b), (c)
3. The system processes a cost-effective rate according to the logistics service provider(s) service rating established by the internal processing system, whereas a logistics service provider is defined as:
   a. Cargo Carrier; an asset-based carrier via air, ocean, rail or overland
   b. Freight Broker; a third-party logistics provider with relationships with carriers
   c. Freight Forwarder; a shipping intermediary for international cargo
   d. Warehousing Facility; warehousing and storage or cross-docking facility for shipment processing
   e. Customs Broker; a licensed clearance agent at the port of entry in country
4. The system processes quotation(s) in variables; depending on the time of transit, mode of transportation, or the logistics service acquired, in which, a competitive quotation(s) will predominately take longer to compose, for operations of transportation.
5. The system processes quotation(s) to importer(s) and exporter(s) based on the scale of responsibility each party holds in terms of payment for the logistics service.

The system processes quotations according to the role and responsibility of the importer(s) and the exporter(s), both parties are presented with international trading term(s) and condition(s) pertaining to logistics service agreed on, and upon approval, processing the shipment is initiated.

The system processes a shipping order, according to the information provided by the importer(s) and exporter(s), and a logistics plan is generated, according to the various stage(s) of the logistics process: The system processes a logistics service order according to the logistics service provider(s) involved in the transaction, in which the shipment becomes a combined effort between the number of logistics service providers together, in the stages mentioned. The system processes intermodal cargo according to a procedure of obtaining the dimensions (lwh) and weights (kgs/lbs) to ensure that adequate rail equipment is used and if any special requirements are taken into account (permits, routes, handling equipment, special equipment, etc.).

According to the commodities transported via rail, the system assigns a classification for the packing group, special handling instructions, and the process by which, the system will haul the commodity according to a set rail cargo means of containment. The system processes rates based on a tariff schedule given by the rail carriers in select origin/destination(s).

The system processes the cargo description according to the commercial invoice, and the documents retained/processed by the user, in the system. The system classifies the cargo according to dimension(s) and equipment(s) that the select shipment(s) can be loaded onto.

The system processes over-dimensional load(s) according to the capacity and set requirements of the rail carrier, in which, there are dimensional restrictions and regulations and weight limit requirements that are required by the system, in order to process the select categories for processing cargo, into different segmented classes; and require licenses, permits, other regulations to be required (i.e. special clearances and equipment(s)).

The system processes dimensional load clearances on select form(s) and connects these cargo quantities according to the rail carrier, that is in the select trade lane(s) i.e. origin/destination.

The system processes general and specialized equipment to meet the needs of the cargo that is being booked into the system. The system categorizes equipment according to the specifications of the rail equipment, organizing, which type(s) of rail equipment are most suitable for a specific cargo type(s), classifying the type of good(s) according to the select HS-number, pertaining to the mode(s) of transportation, that are handled by the system.

The system processes intermodal transportation by rail—the movement of containers overland on container flatcars. Multimodal transport offers several advantages; namely, it minimizes time loss at transshipment points, provides faster transit of goods, reduces burden of documentation and formalities, and saves costs.

The system processes the carriage with container seals as an extra precaution against theft. Intermodal cars come in many different configurations, and the specifics of the design affect the car's ability to transport containers.

The system processes route planning, and designates the coordinates of deciding a route planning and option(s) according to the Intergovernmental Organization for International Carriage by Rail (OTIF), International Union of Railways (UIC), routes of the railway operations in the member-nations, which is integrated onto the platform of national network, and freight corridors of global member-nations. The system processes multimodal, through bills of lading, covering both the ocean and the rail.

The system processes overland carriers in the global, domestic and local freight procurement processes, which are governed by a legislative framework pertaining to the member-nation at all levels of government—municipal, state and federal; there are strict procedures that overland carriers must adhere to according to the legislative framework (acts) of the pertaining regionalities.

The system processes road development and international workings on overland transportation by adopting the member-nation's legislation, and department of transportation's rules and regulations for haulage, within nations (cross-borders).

The system processes the licensing regulations according to civil regulations of member-nations at all levels of governance; to ensure that cargo is loaded up-to the standards of the government's requirements, to avoid any penalties while in operation(s).

The system processes a database of cargo carriers taking into consideration the type(s) of equipment i.e. trailers and power-units that each carrier has in their insured fleet. The system processes carriers according to: The trade lanes serviced (from country-to-country; cross-borders), the specialized equipment(s) that are apart of the carrier's fleet (i.e. types of trailers), the number of power-units, and its distinct trade lane(s) serviced, as well as, the volume/frequency in each trade lane(s).

The system processes an equipment list, that pertains to the type of cargo that is it compatible with, overland; the equipment list ranges from a wide-range of equipment and power-units including:
1. Dry Vans;
2. Refrigerated or Heated Vans;
3. B-Trains;
4. Flatbeds and Drop-decks;
5. Live-bottoms;
6. Extendable and Stretchable;
7. Specialty Trailers (i.e. goosenecks, etc.)

The system processes overland carriers that handle a wide variety of commodities including bulk aggregates, heavy machinery and fabrication, dry and refrigerated, as well as, hazardous materials; all of which, are transportation domestically and locally within and cross-borders by ground freight. The system processes cargo carriers based on their specialty, and filters commodities according to the type(s) of users available for service, for sub-contractual procurement. The factors effecting overland carriers are: Carrier's cost; Competition with other modes of transport or other road carriers; Value of the merchandise; Annual volume; Size per shipment; Total cargo weight; Spring-season weight restrictions in member-nations; Equipment required; Delivery requirements (many drops vs. through movement); and Possibilities of backhaul cargo.

The system represents airline(s) in global, domestic and local scale(s) one market/city only (i.e., Montreal), or across an entire country (i.e., Canada). The system takes on a complex role, as the airline's representative in all aspects including: warehousing, airport ground handling, sales, and operations, cargo handling for the airline, promote the airline's services within that market and accept bookings on behalf of the airline.

The system processes numerous non-competing airlines and has the capacity to invoice the user directly for freight charges incurred. This is especially helpful for the importers and exporters, as they can establish one credit account with through the system and have access to booking shipments to many destinations around the world.

The system processes shipments with air cargo carriers who operate their own aircraft to and from designated hubs. The system processes trade lanes designated to air cargo carriers on global, domestic and local scales, in which, air cargo is expedited and serviced via express, depending on the rating of the cargo. The system understands the complex legal and documentary requirements and be aware of the physical conditions prevalent in a multitude of markets around the globe. The system understands mixed load dimensions and mixed weights and densities, capacity restrictions, aircraft hold dimensions and all the regulations concerning hazardous goods, weight limitations, container loading, and transshipment at transfer points. The system processes complex regulations and has detailed knowledge of the many miscellaneous fees and charges that are part and parcel of moving goods by air, and the legal complexities affecting the disposition of the goods, as well as insurance coverage and procedures in case of damage or loss, and all the licensing regulations.

The system processes its database with air cargo carrier, in which, access to individual airlines are accessible with processing active members; airlines involved in international operations, and associate members; airlines concerned with domestic routings. The system implements processes with quality standards that are measurable to improve the efficiency of air cargo.

The system automates and computerizes air carrier traffic and its various member airlines into a worldwide server system, in conjunction with the International Civil Aviation Organization, the system processes the routes of air carriers for legal air traffic around the world.

The system improves air carrier processes by standardization of documentation, procedures, handling agreements, simplifies clearance documents and procedures at airports, agencies on security problems, financial and accounting systems.

The system has registered air cargo carriers, processed according to air routes and, trade lanes of major import and export operation(s), whereas, there is complete transparency between the airline(s) and the system, for the trade lane(s) serviced the tracking and tracing features are based on the Airway Bill Number (AWB) that is used to trace shipments from booking, tracking and tracing phases. The system processes pre-numbered, and blank airway bills, as agreed upon, by designated air cargo carriers, to issue Airway Bills (AWB), for the carriage of air cargo, supplied according to the booking transaction. A three-digit airline identifier (for example, 014 is the identifier for Air Canada and all its AWB numbers start with 014); and an eight-digit serial number. This number identifies a shipment throughout the transportation process, right up to the delivery at the airport of final destination.

The system processes transaction(s) with air carrier, per-carrier-basis, and sets-up terms and conditions according to each designated account:
1. Account settlement systems are processed directly;
2. Tariff rate(s) and routing schedule(s) are updated within the system;
3. E-documentation; electronic processing of airway bills and required documentations, including (House AWB and Master AWB)
   a. Four key elements: a reference number to access the information record; airport of origin and destination; transit; and weight of shipment.
4. Prior to arrival customs clearance; “wheels up” in other words, it allows the cargo to be customs cleared upon arrival of the aircraft.

The system's processes information beyond turning the goods over to the air carrier at point of origin, ensuring its contractual obligations until the shipment is finally cleared through customs and delivered to the consignee.

The system processes value-added services for the air transportation process, while presuming the cargo booking process; the system processes information regarding:
1. The system has a database for the acceptance/collection of export and import and export shipments;
2. The system prepares the airline documentation, i.e. completing air waybills, including all charges thereon, and ensuring that invoices and commercial documentation meet all the requirements for movement by air to the destination country;
3. The system checks that export licences and import licences are all in order and comply fully with government regulations in each country prior to on-boarding good(s);
4. The system ensures that packing certificates are supplied by exporters of goods (hazardous materials/restricted articles), in compliance with government regulations;
5. The system arranges for carriage and booking space with airlines and scheduling delivery of the goods to the airport;
6. The system ensures that customs export declarations have been completed and submitted to the proper government departments;
7. The system arranges for proof of export where required for customs duty “drawback”;
8. The system processes insurance coverage for clients; and complying with Dangerous Goods Regulations, and Cargo Safety and Security Procedures for Air Cargo Security Program(s) for member-nations; all cargo destined for a passenger aircraft must either come through secure supply chain or be actively screened prior to loading on the aircraft based on World Customs Organization's (WCO) SAFE Framework of Standards and the International Civil Aviation Organization's (ICAO). All cargo destined for a passenger aircraft must either come through the secure supply chain or be actively screened prior to loading on the aircraft.
   a. Cargo Security Plan (CSP)
   b. Transportation Security Administration (TSA)
   c. Security Measures Respecting Air Cargo (SMRAC)
   d. Cargo Security Coordinator (CSC)
   e. Authorized Cargo Representatives (ACRs)

The system processes air cargo through the secure supply chain initiative, allowing importers and exporters to register themselves with relevant air cargo security and safety initiatives, to self-screen, package and monitor their air cargo; ensuring that all cargo going on aircraft is secure cargo, applicably:
1. Importer(s) and exporter(s) are part of a secure supply chain by registering as Account Consignor the Transport Organization of a member-nation (i.e. Transport Canada). The Cargo Security Plan will ensure that the manufacturing, packaging and transportation of export(s) will be done in a secure environment.
2. The system's logistics service providers will be assigned apart of the secure supply chain by registering as Regulated Agent with Transport Organization of a member-nation (i.e. Transport Canada); applying security measures to the shipments it accepts, stores and/or transports and, if it is regulated, it will actively screen shipments and keep them secure.
3. Other cargo carrier, such as overland carriers, warehousing and distribution facilities, will be part of the Secure Supply Chain by applying to become a Certified or Regulated Agent. They will apply security measures to the shipments they accept, store and/or transport.
4. Air cargo carriers will be legislated part of the secure supply chain, applying security measures to the shipments they handle and ensure that either the shipments come from secure supply chain partners or the air carrier applies screening to the shipments.

The Export Process is as follows:
1. The system monitors door-to-door service where the cargo is always processed under the system's consolidation server;
2. The system provides competitive cargo rates for consolidated cargo;
3. The system makes extensive use of unit load devices (ULDs), or aircraft containers and pallets;
4. The system automates communication with the logistics service providers at the country of import and export;
5. The system processes export documentation services;
6. The system negotiates freight rates based on annual tonnage to specific destinations;
7. The system offers various service for less time-sensitive shipments; and,
8. The system processes tracking and tracing of shipments.

The Import Process is as follows:
1. The system organizes pick-up at the point of origin, using overseas cargo carrier and communicating pertinent details via the system's communication devices;
2. The system consolidates air freight rates; tracking and tracing;
3. The system provides pre-advice of arrival, so that the importer is aware of the shipment before it actually arrives at the point of destination;
4. The system processes purchase orders and vendor compliance;
5. The system cooperates with customs broker to arrange customs documentation and clearance formalities at the point of entry;
6. The system provides forwarding under customs bond to domestic destinations for final clearance;
7. The system cooperates with a customs broker to prepare customs forms to allow for temporary importation of goods, i.e., for repair or for exhibitions; reclaim duties paid on temporary importation when the goods are re-exported;
8. The system cooperates with a customs broker or agent to prepay duty and taxes where required and appropriate;
9. The system processes transport insurance; and handles cargo claims.

The system processes different type(s) of cargo aircrafts into its internal database, and it designs a cargo handling, storing and transporting plan according to the user's specifications of cargo requested for transport. The system calculates the payload, total volume, pallets on the main deck and belly.

The system composes a database of air carriers, and the type(s) of aircrafts at various locations, and cycles of origin and destination, to determine which aircraft is most suitable for a user's cargo.

The system processes containers/ULDs (Unit Load Devices) of the airlines, assigned with a ULD has an identification number with three parts: the type of ULD, its serial number, and the name of the airline that owns it.

The system optimizes the loadability of cargo into a container, determining the size of container and cargo load configuration, for optimal load configuration; in the case of a consolidation container, the variety of good(s) and cargo sizes makes stow planning, requiring that each of the types of packages be evaluated for both dimensions and weight distribution, and a container load plan will be required to calculate the optimum stow.

The system processes cargo stowage plans, according to a consolidation plan, configuring the amount(s) of cargo able to be distributed in a particular container(s), according to a set trade lane(s), airline(s) and aircraft(s). The optimal load configuration is determined based on:
1. Trade lane(s) and airline(s) servicing the select consolidation plan(s)
2. The consolidation plan(s) is determined based on the combination of freight forwarder(s) accessing the system's mainframe, for consolidation.
   a. In case of consolidation cargo, homogenous packages are figurative for cargo stowability

The system optimizes the palletization(s) of each cargo according to the dimensions, weight and specific configurations of the cargo. The length and width of the container is divided by the length and width of the packages, to determine the optimum number of packages and loading configuration, per each type of pallet.

The system processes cargo charges, with limitations by both weight and volume. The system processes air carriage rates including pick-up, export and import clearance, delivery, storage charges, the member-nation's navigation surcharge, security, fuel surcharge, terminals and handling.

The system determines the precedence over the freight charge(s) assumed for each classified good(s), and the rule of precedence applied is that specific commodity rates take precedence over class rates and over general cargo rates, except that when the quantity rate for a certain weight break point is lower than a specific commodity rate, such lower rate can be applied; and class rates take precedence over general cargo rates.

The system processes carriage preparation for air operations, providing commodity description(s) and the required, handling instruction(s) associated with each type of commodity. The system processes these documents according to a commodity code(s) process for air shipments. Packaging; withstand all normal transportation incidents, they will not deteriorate or damage other goods during transportation; care in handling; piece of property must be legibly and durably marked, to identify the name and full address of the shipper and the consignee. Labelling and Marking; package weight; size of the aircraft hold or of the container, may also specify if any additional markings are required, including transfer points between shipment(s). Barcoded Labels; standard guidelines for bar coded labels. Basic Label; The three-digit numeric airline prefix and a hyphen (The eight-digit numeric air waybill number (a single-digit separator (always zero)); A four-digit numeric consecutive piece number indicating each unique piece in a multi-piece shipment. If this field is not used, it shall comprise four zeros; and One standard check digit (the check digit will not be printed in human readable form)); Secondary Label; printed on a label, the bar code containing the house waybill number must be printed first; Marking of Package; consignee's name, street and city address as on the air waybill.

The system process air waybills electronically documenting the contract of carriage as receipt for the goods being shipped; which acts as a certificate of insurance; and it guides the carrier in handling, dispatching and delivering the goods.

The system processes requested flight(s) for the shipper/consignee and the freight forwarder. If a connecting flight is involved, the flight number to ensure there is enough time for the transfer from incoming to outgoing aircraft at the connecting airport.

The system processes the parties signing the charter agreement responsible for all charges. The cost is determined by the charter operator and is based on a roundtrip journey, including all additional fees (i.e. ferry charge, licenses and permits) involved in the transaction.

The system is acting as an NVOCC (non-vessel-operating common carrier) whose service contract is fully incorporated into the contract of carriage however it ensures to indemnify the carrier in full for any costs or liabilities that may arise after processing a steamship line booking.

The system processes carriers based on their rank in global positions, and internally ranks the carriers for their credibility by (a) rates (b) delivery performance (c) cargo liability (d) type of commodity (e) lane(s) of trade service for every point of origin and destination. The system processes real-time data based on the exchange of good(s) and booking(s) processed with ocean carriers, determining a preferred ocean carrier network relative to its capacity, tariff and booking schedule(s) updated on a daily basis, for other users that are processing shipments for set trade lanes.

The system's advantage of using the ocean freight procurement strategies to process seamlessness in shipping cargo via ocean(s), by using a number of logistics service providers who have specialized rate(s) with different ocean carriers, based on volume and frequency of exchange.

The system processes the rules and regulations for shipping, containing and assessing ocean freight shipments according to the standards of the International Maritime Organization, International Maritime Dangerous Goods Code (IMDG Code), for the safe transportation of dangerous goods or hazardous materials by water.

The system modernizes the contracts of maritime transportation of goods based on the Carriage of Goods by Sea Act (COGSA) and facilitates harmonization and standardization of commercial shipping practices and contracts.

The system processes the major gateways ports across the world, according the UN/LOCODE which is developed and maintained by the United Nations Economic Commission for Europe (UNECE) which assigns codes to locations used in trade and shipping, such as ports, airports, rail terminals, truck terminals and border crossing points.

In addition, the system processes the ocean routes for navigational purposes, and determining the possibility of route(s) taken by ocean carriers from the point of origin to the end-destination.

The system processes major canals, inland rivers and waterways across the world and trading routes in Europe; The Far East/Pacific Rim; Middle East and India; and Central and South America.

The system processes various commodities for marine transportation, composing of the following good(s) below; and, the good(s) are processed according to packing groups, type(s) of vessels for loading, container type(s), and cargo handling instructions given by the shipper. The information for commodities are classified according to the HS-number, as well as, the rules and regulations pertaining to each mode of transportation(s).

The system processes commodities in a standardized way, which, in turn calculates the volume and the weight requirements, and which container/loading type(s) the cargo is most compatible in: Number of Pieces (in the shipment); Weight of the Cargo (lbs/kgs); Dimensions of the Cargo (lwh).

Regarding Bulk Cargo: The system processes commodities that are transported unpackaged in large quantities, usually pumped and blown into ships' holds. It represents the largest volume of maritime commerce. (Dry bulk cargo: i.e. minerals cement, resin powder, fertilizer, coal, flour, sugar, grain, iron ore, etc. Liquid bulk cargo: petroleum products (oil, liquified natural gas, gasoline), chemicals, edible liquids (cooking oil, vegetable oil), rubber, etc.).

Regarding Break Bulk Cargo: The system processes “conventional cargo” involving packaged and non-packaged goods (i.e. machinery) being lifted individually by way of cranes and lowered into the vessel's holds.

Regarding Containerized Cargo: The system processes consolidation activity of non-packaged goods and machinery into standard-size ocean containers. The criterion is that the cargo must fit the confines of the container frame and meet the weight limit standards.

Regarding Roll-on/Roll-off Cargo: the system processes roll-on/roll-off cargo, based on mobility, as the cargo is either driven under their own power or towed onto the ship, generally out-of-gauge cargo is also often shipped on RO-RO ships.

Regarding over-dimensional cargo: the shipment processes Oversize or, over-dimensional cargo that does not fit in a standard ocean container and, must be shipped break bulk, roll-on/roll-off or on a specialized container (open-top, flat-rack or platform).

The system processes general cargo vessels, matching the type of commodity according to the available of the cargo vessel, at the required port of entry in select member-nations. The advantage of matching commodities to vessels, is for the purpose of accuracy, and therefore, a database for commodities, with select packing groups, and the type of vessel it can be hauled onto is important.

The system processes containers into a number of different groups, according to the type(s) of commodities being loaded, when the type of container is selected it provides additional information for cargo handling and what type(s) of attributes to add with the container(s) for special purposes of safety in haulage, for example: general cargo containers; reefer containers; tank containers; (dry) bulk containers; platform containers; livestock containers; nuclear-materials containers; and automotive containers.

The system processes an interwoven connection with the ocean carrier's personnel, whom provides the container number and the identification number of the container, for tracking and tracing purposes, which is integrated into the portal on the mainframe of the system. The unit number comprises 11 letters and numbers: three letters for the owner's SCAC (standard carrier alpha code), as assigned by Bureau International des Conteneurs (BIC), a one-letter equipment category identifier, a six-digit serial number and a single check digit that is calculated to validate the recording and transmission accuracies of the owner code and serial number. A sample unit number is BICU 123 456 5. A code to denote the country the container is registered in. The code is the same as used by that country's distinguishing signs for motor vehicles in international traffic. A Transports Internationaux Routiers (TIR) designation, if the container is authorized under the provisions of the International Customs Authority requirements for TIR carnets.

The system processes container classification providing information on the attributes of the container(s), listing the features and exclusive use(s) of the container as well as loading and handling instructions, which are provided in the “appendixes” of the system.

The system processes load planning (less-than-container load consolidation by calculating the loadability of cargo into a container, determining the optimum size of container and cargo load configuration. The system specifies the rental rate of container(s) and the consolidation plan/packages of each container by weight, volume and dimensions (lwh) indicating to logistics service providers, to operate within a network of logistics service providers for consolidation activity, and allowing users to take advantage of transparent pricing and rate(s). The length and width of the container is divided by the length and width of the package(s), to determine the optimum number of packages the container can accommodate and the best-possible loading configuration.

The system has a consolidation network, in which a number of users, and logistics service providers (freight forwarders) are able to consolidate containers in a specific origin, and set location (i.e. warehouse) for shipping goods to a designated destination. This feature on the system is accessible by users and logistics service providers, who are able to generate barcode labels for their shipment(s) on-boarding a consolidated container, and processed in a select distribution center in the destination country. The system processes a hub integration method for consolidation, in which major container routes are the concentration of cargo at dedicated load centres, attracting as much cargo as possible to major hubs and destinations.

The system processes chartering of shipping that requires specific skills and know-how, depending on the amount of volume and frequency of the shipments in any point of origin to a select destination; in which the system consolidate the entire vessel: When there is enough cargo to warrant the exclusive use of a vessel (approximately 1,000 freight tons); When there is no regular service to the required destination (small ports); or Due to the nature of the cargo (e.g., telephone poles, explosives, etc.). Other charges may include terminal handling charges, at both origin and destination; fuel surcharge (based on the fluctuations of the price of bunker oil); currency surcharge (based on the fluctuations of the U.S. versus the Canadian dollar); and security surcharge.

Certain variables may be considered. The system processes records of ocean freight trend(s) that are published and accessible to users and logistics service providers for trade references and statistical purposes for rate cycles for good(s) per annum. This information allows users to plan budgets for their transportation and logistics service(s) and procurement strategies of freight either imported or exported, in addition, consider trends for negotiating sales contracts with importers and exporters.

Peak season surcharges assessed when ships start getting full, for example, in anticipation of heavy year-end trade; Low water surcharges that are added to transatlantic trade when the water level in the St. Lawrence Seaway is unusually low and does not accommodate ships loaded to full capacity; Special equipment surcharges applied to open-top containers, reefers, etc.; Equipment imbalance surcharges assessed by some carriers when containers are shipped to a low-demand area; and Winter surcharges applied on Baltic trade between December and April.

Regarding bookings, the system enables the user (importer or exporter, or both) to hold title to their goods intended to be shipped, retain a booking number and a booking confirmation. The system processes the following information for a booking request:
Booked by name of the shipper/logistics service provider
Party:
Service e.g., CY/CY
Mode:
From: city, province, country (origin)
To: city, country (final destination)
Service completed when there is a service contract in place. Some users may have
Contract: access to service contract with ocean carriers pursued by the system. Service contracts provide a series of privileges, such as favorable freight rates, access to credit terms, web or remote agreements for printing bills of lading, disclosure to release bills to the shipper once the forwarder receives their freight, forwarder's commission, etc. The system establishes a relationships with a steamship line, conducting business becomes much easier.
Customer type of cargo, e.g., lumber.
Cargo:
Business the branch of the steamship line making the booking.
Unit:
Ref. No.: steamship line's own reference number.
PRN #: proof of reporting number. The PRN and the CAED (export declaration) must be submitted by the shipper/forwarder to the carrier the same day as the cut-off.
The booking will rolled: the cargo will be moved to the next available departure time. Roll fees and be demurrage charges are penalties/charges against shippers or consignees for delaying the carrier's equipment or vessel beyond the allowed free time. The free time and demurrage charges are set forth in the charter party or freight tariff.
Equipment
Size/Type/Height: e.g., 40-ft dry 9 ft 6 in
Gross weight: the weight of the shipment, its container and packing material; in kilograms.
Pack. Qty/Kind: e.g., 30 wooden pallets.
Cargo volume: volume weight in cubic metres, if applicable.
Intended Transport Plan
From: name of the departure terminal, e.g., Delta Port Terminal.
To: name of the arrival terminal, e.g., Hong Kong/Modern Terminals Ltd.
Vessel: name of the vessel that will carry the cargo.
Voy. No.: number of the specific voyage.
ETD: estimated time of departure (day, month and year) of the vessel.
ETA: estimated time of arrival (day, month and year) of the vessel.

### Load Itinerary

Location: complete names and addresses of the empty container depot and the return equipment delivery terminal.
Berthing: sufficient space for a vessel to maneuver to dock or anchor.

Regarding preparation for carriage, the following is evaluated: Type of cargo: does the cargo require ventilation, refrigeration, etc.? Size of cargo: is special access and/or handling required? Weight of cargo: is weight distribution an issue? Bearing in mind possible road weight restrictions, is inland transport a requirement? Density of cargo: high-density cargo requires less container space and may not be economically suitable in longer containers. On the other hand, low-density (high volumetric) cargo benefits from larger container sizes. Packing and unpacking facilities: there is a need to ensure, at both the origin and destination facilities, that the cargo can be suitably and easily handled in the container. Fixing/securing points required for various cargos must be sufficient in number, strong and well-positioned to accomplish the task.

Regarding transportation documents: The system processes an ocean bill of lading which has three functions: (a) It is a receipt for the goods; It is a contract of transport; and (b) When issued in original form, consigned to order or to order of shipper and blank endorsed, it becomes a transferable title of ownership, i.e., whoever holds the original bill of lading, first the shipper, then subsequent parties to the transaction (bank, buyer) can claim the goods from the carrier.

The system processes a letter of indemnity, holding the logistics service provider harmless in respect of any liability, loss, damage or expense of whatsoever nature by reason of delivering the Cargo.

The system processes a financial bank guarantee, for payment to the other user unconditionally on the written demand(s) in the form of a signed letter certifying the amount demanded is a sum due to be paid.

Regarding arrival at the destination: The system processes arrival at the destination port, and processes customs clearance requests on behalf of the importer and exporter, meanwhile allowing the carrier's destination office or agent to transmit the manifest information (i.e., the bill of lading information of all the shipments on board that particular vessel) to the local customs office and issues arrival notices to the consignees and/or their agents. The importers files the customs entry and the documentation required for customs clearance with the local customs authorities through the system. Upon receipt of the customs release, payment of relevant charges (i.e., ocean freight, terminal handling and the customary local charges, if they were not prepaid at origin) and the original bill of lading (duly endorsed, if issued to order), the system releases the shipment to the consignee. There could also be demurrage and detention charges. Demurrage is generally charged by the port/terminal operator to cover the storage of the container at the facility, whereas detention is charged by the carrier, it is a “rental” fee, if you keep its container(s) longer than agreed. Access to Ports for Truckers; The system coordinates with ground carriers to access the port facilities, to coordinate the who must be registered with the port and their driver need a port access card or pier pass.

Regarding the Customs Appeal Process: Errors in processing transaction(s) with customs agencies in member-nations occur when importer(s) or exporter(s) are not in “compliance” with the laws, acts, regulations or mandates made pertaining to the Customs Act, Customs Tariff, and Tax Act(s) of member-nations. If additional duty or taxes are owed, they must be paid immediately within 30 days. If the importer disagrees with the customs agency's determination, then re-determination can be sought, by filing a request for re-determination, under Section 60 of the Customs Act within 90 days of the Section 59(2) notice. (a) The request may be made after amount(s) owed including interest are paid, or the importer files security. (b) The customs agency will require 14-30 business days to give a ruling on the “redetermination”. The customs agency is expected to make a decision, within 180 days after the dispute notice is filed, or, it maybe referred to an upper level Trade Tribunal. If importers disagree with the ruling, an appeal can be sought with the Trade Tribunal under Section 677 of the Customs Act within 90 days of the decision. If importers disagree with the decision of the appeal judge(s), an appeal can be made in the Federal Court, and it must be filed, within 90 days.

The system is the logistics service provider, that connects users (i.e. importers and exporters) with end-to-end visibility of their supply chain; connecting them to legally operating logistics service providers (i.e. customs brokers, freight forwarders, cargo carriers and warehousing and distribution facilities) on a global, domestic and local scale; on which, they can control their supply chain; by comparing rate(s), service(s) of logistics service provider(s), and meeting specialized logistics service provider(s) through a platform that increases safety, compliance and security of their global supply chain; by determining their logistics budget(s) according to industry-trend(s) on an up-to-date basis (daily, weekly, monthly, quarterly and annually); by planning their logistics schedules with global, domestic and local logistics service provider(s) on a cost-effective and profit-maximizing approach; by electronically controlling, adjusting and processing their supply chain(s) at every scale and process at various geographical scales.

The system processes logistics service(s) into phases, allowing the user to have control over their supply chain at every step of the logistics service process, ensuring there is complete transparency and traceability of their shipment.

The system processes information through a flow-network, built and compatible based on “processes,” in which there are problems, and solutions are derived, for complete end-to-end compatibility. The system processes logistics service providers to enter, join and process shipments on the system, when a logistics service provider processes a quotation(s) on the system, the logistics service provider is informed to integrate the door-to-door transportation intermediaries on-to the system, for the user's complete visibility.

The logistics service provider integrates other logistics service providers, on-to the platform, for visibility The logistics service providers (i.e. cargo carriers, customs brokers, and freight forwarders) create an account, filling out the requirement(s) of the system, and are assigned to a shipment based on the rewards system. The logistics service provider holding a competitive rate(s) to a select shipment integrates the logistics service providers who are sub-contracted by the logistics service provider for the user's visibility.

The system integrates the logistics service provider(s) and intermediary processing location(s) at every point, as well, including the screening facilities, port authorities, terminal location(s) and other(s) whom are involved in the end-to-end process.

The system also allows the logistics service providers (i.e. freight forwarders or freight brokers) to process select shipment(s) as long as the shipping process is handled from end-to-end, at every point that they are quoting, without revealing the links to their supply chain, nor, specifying the cost(s) of booking with select intermediaries, however permissions of what they can and cannot quote on, are arranged and set according to the system. The diagram below shows a general overview of the system in terms of the logistics service provider(s) on the system: (note: each column is a step in the logistics process, and the table can be transformed into a diagram showing the steps in the process of the system, and the role of intermediaries in each step)

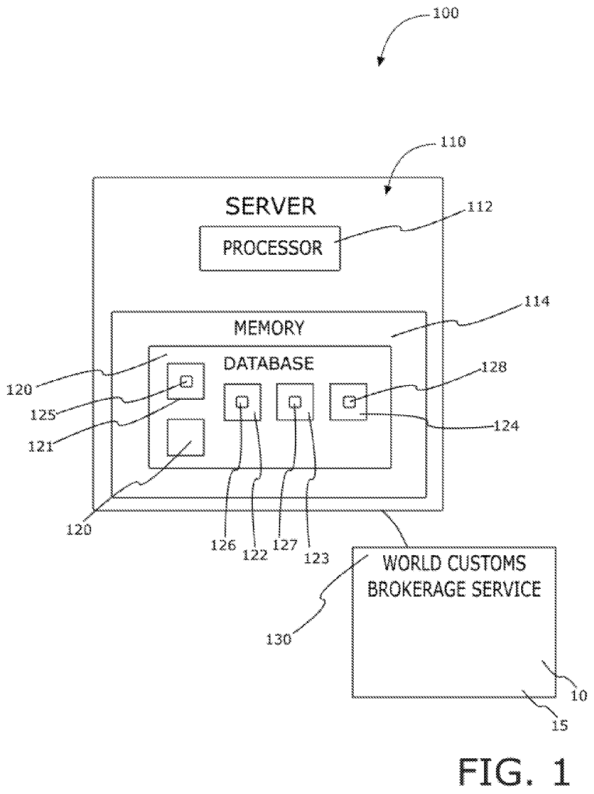

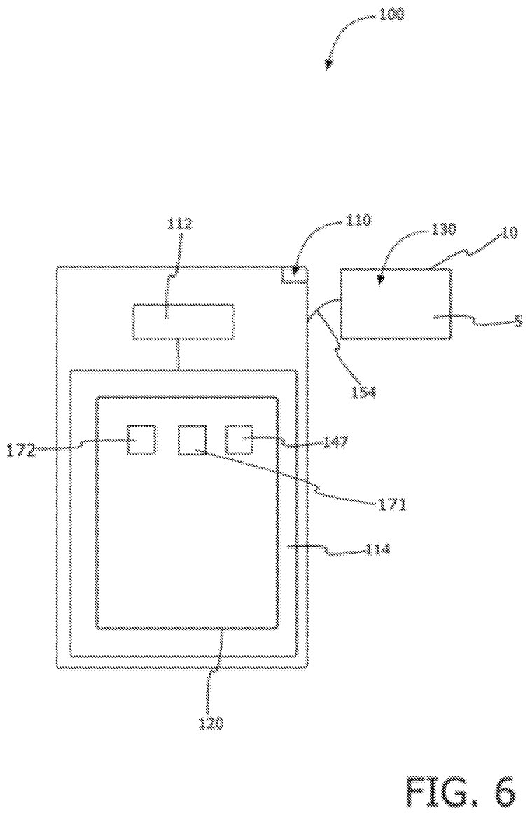

Referring now more specifically to the drawings by numerals of reference, there is shown in FIGS. 1-6, various views of a system for facilitating international trade 100. FIG. 1 shows a system for facilitating international trade 100 according to an embodiment of the present disclosure. Here, the system for facilitating international trade 100 may be beneficial to connect businesses and licensed customs brokers. As illustrated, the system 100 for facilitating international trade 100 may include a server 110 including a processor 112 and a memory 114 in communication with the processor 112. The memory 114 includes a database 120 comprising at least four tables. The at least four tables includes a first-table 121 including at least one customs-broker profile 125, a second-table 122 including at least one trade-company profile 126, a third-table 123 including at least one customs-stage file 127, and a fourth-table 124 including at least one administrative-file 128. The system 100 further comprises a software application for use with a device 5 including a user-interface 10 configured to enable communication with the server 110.

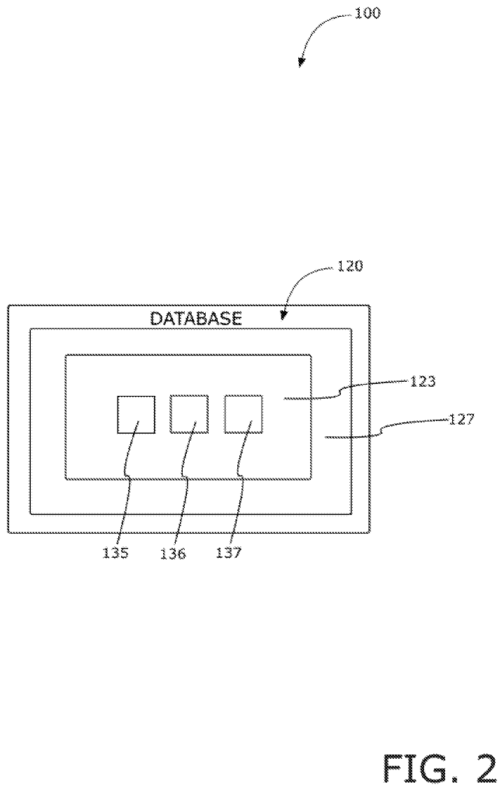

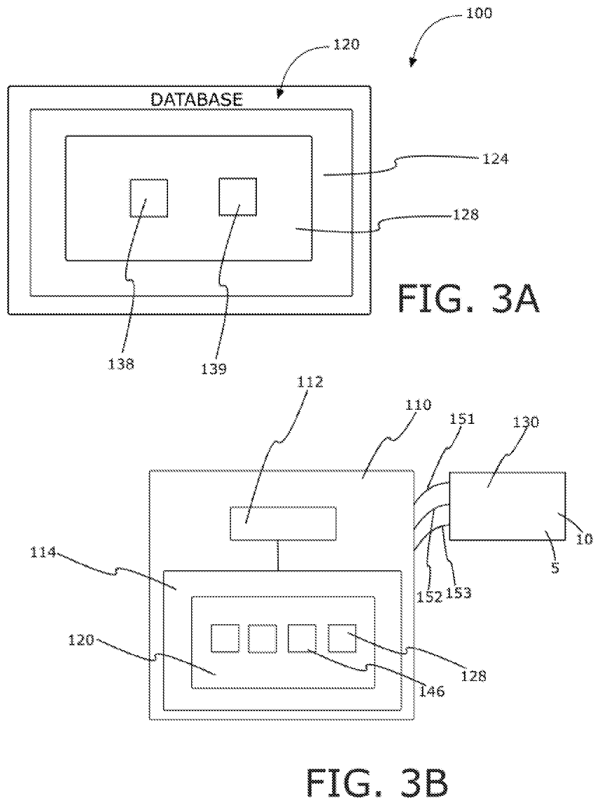

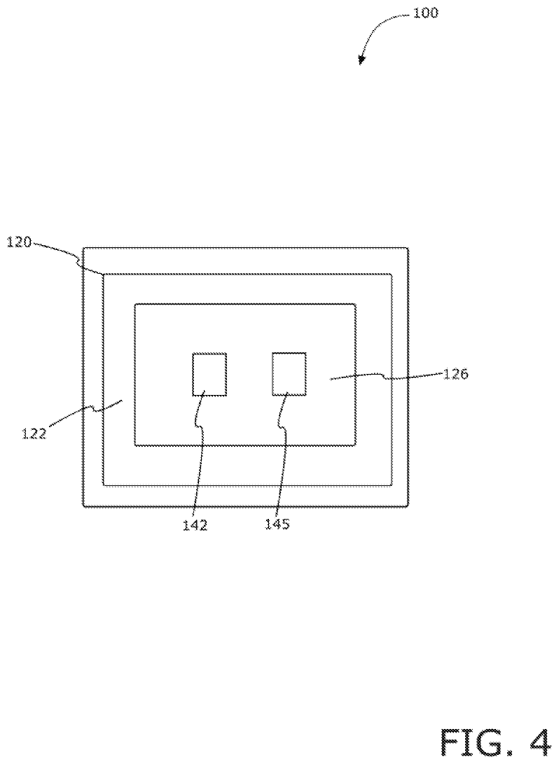

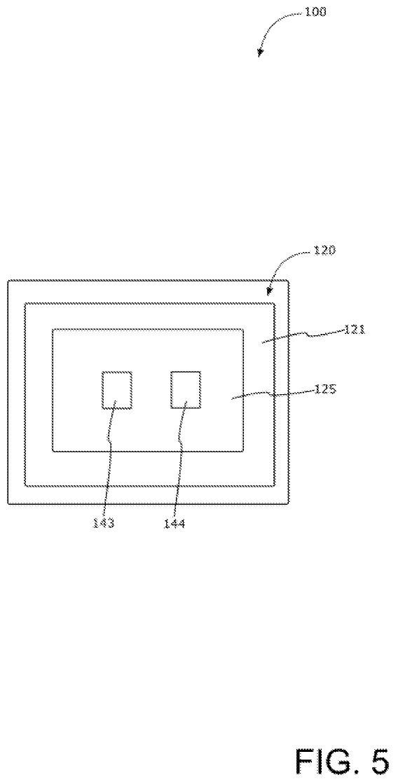

The database 120 further comprises at least one customs-agency profile which is categorized by country. The at least one customs-stage file 127 as shown in FIG. 2 may include at least one pre-release customs-stage file 135, at least one release customs-stage file 136, and/or at least one post-release customs-stage file 137. The at least one administrative-file 128 as shown in FIG. 3A may include at least one customs-form file 138, and at least one regulation-file 139. The at least one administrative-file is categorized by country. The at least one administrative-file is further categorized by customs-stage. The at least one trade-company profile 126 as shown in FIG. 4 includes at least one company-information file 142 and at least one shipping-information file 145. The at least one customs-broker profile 125 as shown in FIG. 5 comprises at least one country-information file 143. The at least one customs-broker profile 125 further includes at least one qualification-information file 144.

The processor 112 is configured to receive a customs-stage input 151 and a country-input 152 at the user-interface 10; and the processor 112 is further configured to retrieve a corresponding at least one administrative-file categorized by the country and the customs-stage. The processor 112 is configured to receive stage-information 153, generate at least one stage-information file 146, and store the at least one stage-information file 146 on the database 120. The system 100 further comprising a payment-interface, whereby the processor 112 is configured to receive and process payment-information 154, generate at least one payment-information file 147, and store the at least one payment-information file 147 on the database 120. Further, the database 120 includes at least one commodity-file 171 and the processor 112 is configured to generate at least one quotation-file 172 and store the at least one quotation-file 172 on the database 120.

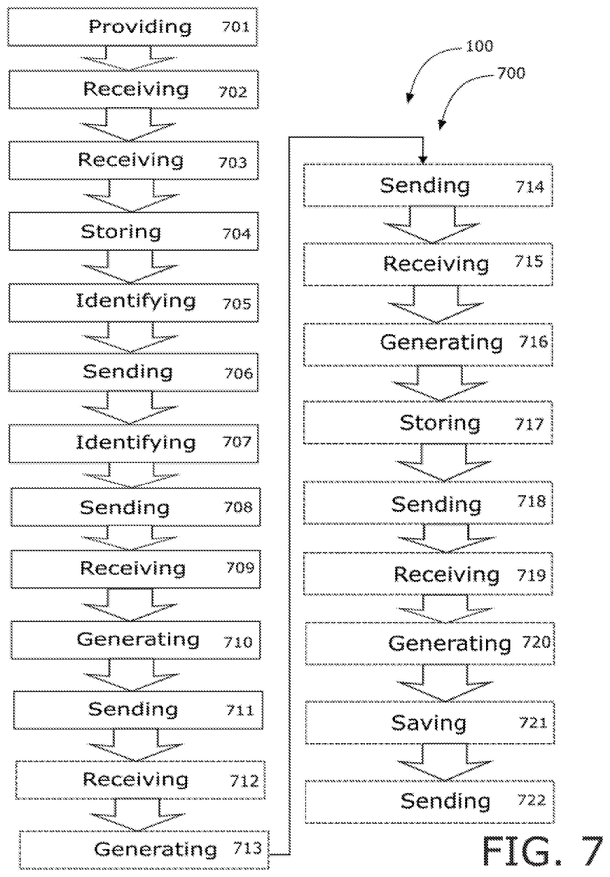

Referring now to FIG. 7 showing a flow diagram illustrating a method of use 700 for facilitating international trade, according to an embodiment of the present disclosure. In particular, the method of use 700 may include one or more components or features of the system 100 as described above. As illustrated, the method of use 700 may include the steps of: step one 701, providing a system for facilitating the international trade 100, the system 100 including a server 110 including a processor 112, and a memory 114 in communication with the processor 112, the memory 114 having a database 120 comprising at least four tables including a first-table 121 having at least one customs-broker profile 125, a second-table 122 having at least one trade-company profile 126, a third-table 123 including at least one customs-stage file 127, and a fourth-table 124 including at least one administrative-file 128, and a device 5 including a user-interface 10 configured to enable communication with the server 110; step two 702, receiving at the server 110 a request for retrieval of the at least one administrative-file via a trade-company profile; step three 703, receiving at the server 110 at least one shipping-information file 145; step four 704, storing the at least one shipping-information file 145 on the database 120; step five 705, identifying an appropriate customs-broker from the at least one customs-broker profile; step six 706, sending the shipping-information file to the appropriate customs-broker; step seven 707, identifying an appropriate customs-agency from at least one customs-agency profile; step eight 708, sending the at least one shipping-information file 145 to the appropriate customs-agency; step nine 709, receiving at the server 110 an agency-decision; step ten 710, generating an agency-decision file; step eleven 711, sending the agency-decision file to the appropriate customs-broker; step twelve 712, receiving at the server 110 an agency-approval; step thirteen 713, generating an agency-approval file; step fourteen 714, sending the agency-approval file to the appropriate customs-broker; step fifteen 715, receiving at the sever a release-request; step sixteen 716, generating a release-request file; step seventeen 717, storing the release-request file on the database 120; step eighteen 718, sending the release-request file to the trade-company profile; step nineteen 719, receiving a customs-update from the appropriate customs-agency; step twenty 720, generating a customs-update file; step twenty-one 721, saving the customs-update file on the database 120; and step twenty two 722, sending the customs-update file to the trade-company profile. Those with ordinary skill in the art will now appreciate that upon reading this specification and by their understanding the art of software and international trade as described herein, methods of facilitating international trade will be understood by those knowledgeable in such art.

It should be noted that step twelve 712 through step twenty-two 722 are optional steps and may not be implemented in all cases. Optional steps of method of use 700 are illustrated using dotted lines in FIG. 7 so as to distinguish them from the other steps of method of use 700. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for facilitating international trade, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for facilitating international trade, the system comprising:
a server including:
a processor; and
a memory in communication with the processor, the memory having:
a database comprising at least four tables, the at least four tables including:
a first-table including at least one customs-broker profile;
a second-table including at least one trade-company profile;
a third-table including at least one customs-stage file; and
a fourth-table including at least one administrative-file; and
a software application for use with a device including:
a user-interface configured to enable communication with the server.

2. The system of claim 1, wherein the database further comprises at least one customs-agency profile.

3. The system of claim 2, wherein the at least one customs-agency profile is categorized by country.

4. The system of claim 1, wherein the at least one customs-stage file comprises at least one pre-release customs-stage file.

5. The system of claim 4, wherein the at least one customs-stage file further comprises at least one release customs-stage file.

6. The system of claim 5, wherein the at least one customs-stage file further comprises at least one post-release customs-stage file.

7. The system of claim 1, wherein the at least one administrative-file includes at least one customs-form file.

8. The system of claim 7, wherein the at least one administrative-file further includes at least one regulation-file.

9. The system of claim 7, wherein the at least one administrative-file is categorized by country.

10. The system of claim 9, wherein the at least one administrative-file is further categorized by customs-stage.

11. The system of claim 9, wherein the processor is configured to receive a customs-stage input and a country-input at the user-interface; and wherein the processor is further configured to retrieve a corresponding at least one administrative-file categorized by the country and the customs-stage.

12. The system of claim 1, wherein the at least one trade-company profile includes at least one company-information file.

13. The system of claim 1, wherein the at least one customs-broker profile comprises at least one country-information file.

14. The system of claim 13, wherein the at least one customs-broker profile further includes at least one qualification-information file.

15. The system of claim 1, wherein the at least one trade-company profile includes at least one shipping-information file.

16. The system of claim 1, wherein the processor is configured to receive stage-information, generate at least one stage-information file, and store the at least one stage-information file on the database.

17. The system of claim 1, wherein the database further includes at least one commodity-file.

18. The system of claim 1, wherein the processor is configured to generate at least one quotation-file and store the at least one quotation-file on the database.

19. The system of claim 1, further comprising a payment-interface, whereby the processor is configured to receive and process payment-information, generate at least one payment-information file, and store the at least one payment-information file on the database.

20. A method for facilitating international trade, the method comprising:
providing a system for facilitating the international trade, the system including:
a server including:
a processor; and
a memory in communication with the processor, the memory having:
a database comprising at least four tables, the at least four tables including:
a first-table including at least one customs-broker profile;
a second-table including at least one trade-company profile;
a third-table including at least one customs-stage file; and
a fourth-table including at least one administrative-file; and
a software application for use with a device including:
a user-interface configured to enable communication with the server;
receiving at the server a request for retrieval of the at least one administrative-file via a trade-company profile;
receiving at the server at least one shipping-information file;
storing the at least one shipping-information file on the database;
identifying an appropriate customs-broker from the at least one customs-broker profile;
sending the shipping-information file to the appropriate customs-broker;
identifying an appropriate customs-agency from at least one customs-agency profile;
sending the at least one shipping-information file to the appropriate customs-agency;
receiving at the server an agency-decision;
generating an agency-decision file; and
sending the agency-decision file to the appropriate customs-broker.
